(19) United States
(12) Patent Application Publication
(10) Pub. No.: US 2020/0097758 A1
(43) Pub. Date: Mar. 26, 2020

(54) METHOD AND SYSTEM FOR OBJECT DETECTION AND CLASSIFICATION

(71) Applicants: MECTHO S.R.L., Pademo Dugnano (IT); POLITECNICO DI MILANO, Milano (IT)

(72) Inventors: Alessandro Lorenzo BASSO, Paderno Dugnano (IT); Mario GALIMBERTI, Paderno Dugnano (IT); Cesare ALIPPI, Lierna (IT); Giacomo BORACCHI, Buccinasco (IT); Manuel ROVERI, Lodi (IT)

(21) Appl. No.: 16/620,651

(22) PCT Filed: Jun. 7, 2018
(86) PCT No.: PCT/IB2018/054119

§ 371 Date: Dec. 9, 2019

(30) Foreign Application Priority Data
Jun. 9, 2017 (IT) 102017000064268

(51) Int. Cl. G06K 9/62; G06K 9/00; G06K 9/32

(52) U.S. Cl. CPC G06K 9/6211; G06K 9/00771; G06K 9/3241; G06K 9/6267; G06K 9/00208

(57) ABSTRACT

A detection device (1) including: a sensor configured to emit a monitoring signal representing a scene (S), a control unit (4) connected to the sensor. The control unit is configured to: receive the monitoring signal from the sensor, estimate a three-dimensional representation of the scene (S) as a function of said monitoring signal, determine an inspection region (V) from the three-dimensional representation of the scene, provide a classifier with a representation of the inspection region (V), determine, by means of the classifier and based on the representation of the inspection region (V), the presence of people (P) and/or specific objects (C) in the representation of said inspection region (V).

### FIELD OF THE INVENTION

The present invention regards a device and method for detecting people and/or objects of various types—such as for example baggage, packages, bags, paper bags. The present invention can for example be used in the transportation industry (for example airports) for analysing and recognising people and/or objects in critical areas, such as for example the airport check-in area, the airport technical area separated from the public area. The present invention may also apply to the logistics industry for analysing and recognising an object for appropriate classification thereof.

The present invention may also apply to safety systems for identifying attempts of fraudulent access by people through control areas, for example for anti-piggybacking and/or anti-tailgating solutions.

### STATE OF THE ART

Currently known are classifiers, in particular artificial neural networks, used for detecting the presence of objects or people in a scene: the classifiers—without being explicitly programmed—provide a machine with the capacity to acquire given information of the scene. In order to perform the desired functions, it is however necessary that the classifiers, be trained by means of a known learning step prior to be being used. Specifically, classifiers—as a function of the learning data—are autonomously configured so that they can then classify unknown data with a certain statistical uncertainty.

However, it is clear that common calculators, available and generally used at industrial level, enable implementing classification processes exclusively based on two-dimensional images, essentially due to reasons related to calculation times and available memory. These limitations make the use of classifiers critical especially when it comes to cases requiring quick times of analysis. Furthermore, when used, the classifiers generally require the sub-sampling of the images (scaling and/or selecting regions of interest) with the aim of reducing the computational load. The criticalities limit, especially at industrial level, the use of classifiers and information content of the input data, thus reducing the accuracy that can be achieved in the recognition/detection of people and/or particular categories of objects in a scene.

### OBJECT OF THE INVENTION

The object of the present invention is to substantially overcome at least one of the drawbacks and/or limitations of the previous solutions.

A first object of the invention is to provide a device and a relative detection method capable of enabling an efficient and quick identification of objects and/or people in a scene; in particular, an object of the present invention is to provide a detection device and method capable of further enabling the location of objects and/or people in the scene. Furthermore, another object of the invention is to provide a detection device and method that is flexible to use, applicable in different fields; in particular, an object of the present invention is to provide a detection device and method that can be used to simultaneously detect classes of subjects and objects very different from each other and that is simultaneously quickly re-adaptable. A further object of the invention is to provide a detection device that is compact, that can be easily integrated with systems of various types (for example systems for transferring articles, safety systems, etcetera) without requiring complex adaptations or changes to the installations in use. One or more of the described objects and which will be more apparent in the following description are substantially achieved by a detection device and method according to what is outlined in one or more of the attached claims and/or the following aspects, considered alone or combined with each other in any manner or combined with any of the attached drawings and/or in combination with any one of the further aspects or characteristics described below.

### SUMMARY

In a 1ₛₜ aspect a detection device (1) is provided for, comprising:
at least one sensor configured to emit at least one monitoring signal representing a scene (S),
at least one control unit (4) connected to the sensor and configured to:
   receive the monitoring signal from the sensor,
   estimate a three-dimensional representation of the scene (S) as a function of said monitoring signal,
   determine, in particular extract, an inspection region (V) from the three-dimensional representation of the scene,
   provide a classifier with a representation of the inspection region (V),
   determine—through the classifier—the presence of people (P) and/or specific objects (C) in the representation of said inspection region (V) based on the representation of the inspection region (V).

In a 2^{nd} aspect according to the 1st aspect, the control unit (4), as a function of the monitoring signal, is configured to estimate a three-dimensional representation of the scene (S).

In a 3^{rd} aspect according to any one of the preceding aspects, the control unit (4), as a function of the monitoring signal, is configured to define a cloud of points (N) as an estimate of the three-dimensional representation of the scene (S).

In a 4^{th} aspect according to the 2nd or 3rd aspect, the three-dimensional representation of the scene comprises a three-dimensional image, optionally a depth map, representing the scene (S) consisting of a pre-set number of pixels,

In a 5^{th} aspect according to the preceding aspect, the control unit (4) is configured to allocate to each pixel of the three-dimensional image—of at least part of said pre-set number of pixels—an identification parameter, optionally representing a position of said pixel in the space with respect to a pre-set reference system.

In a 6^{th} aspect according to the preceding aspect, the control unit (4)—during the step of determining the inspection region (V)—is configured to:
compare a value of the identification parameter of at least one pixel of the three-dimensional image—of at least one part of said pre-set number of pixels—with at least one reference parameter value,
following said comparison step, define the inspection region (V) as a function of a pre-set relationship between at least one reference parameter value and the identification parameter value of the pixels of the three-dimensional image of at least part of said pre-set number, optionally said pre-set relationship being a difference between at least one reference parameter value and the identification parameter value of the pixels of the three-dimensional image of at least part of said pre-set number.

In a 7^{th} aspect according to the preceding aspect, the reference parameter comprises at least one among:
a relative position of each pixel with respect to a pre-set reference system,
a relative position between two or more bodies, for example people and/or objects, defined by the cloud of points,
a shape of one or more bodies for example people and/or objects, defined by the cloud of points, optionally depending on at least one among planarity, sphericity, cylindricity of one or more bodies defined by the cloud of points,
a dimension of one or more bodies, for example people and/or objects, defined by the cloud of points,
chromatic values of the cloud of points or parts thereof.

In an 8^{th} aspect according to the 6^{th} or 7^{th} aspect, the reference parameter comprises a plurality of reference values regarding spatial coordinates of a virtual region representing the inspection region (V).

In a 9^{th} aspect according to any one of the 5^{th} to the 8^{th} aspects, said identification parameter of each pixel comprises at least one selected among:
a distance, in particular a minimum distance, of said pixel from an origin defined by means of spatial coordinates of a three-dimensional Cartesian reference system,
a distance, in particular minimum distance, of said pixel from an origin defined by means of polar coordinates of a cylindrical coordinate reference system,
a distance, in particular minimum distance, of said pixel from an origin defined by means of polar coordinates of a spherical coordinate reference system,

In a 10^{th} aspect according to any one of the preceding aspects, the sensor comprises at least one among: a 2D camera, a 3D camera.

In an 11^{th} aspect according to any one of the preceding aspects, the sensor comprises at least one among: an RGB camera, an RGB-D camera, a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 12^{th} aspect according to any one of the preceding aspects, the device (1) comprises at least one first sensor (5) and at least one second sensor (7) distinct from each other.

In a 13^{th} aspect according to the preceding aspect, the first sensor (5) exclusively comprises a three-dimensional type camera.

In a 14^{th} aspect according to the 12^{th} or 13^{th} aspect, the first sensor (5) comprises at least one among: a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 15^{th} aspect according to any one of the 12^{th} to 14^{th} aspects, the first sensor (7) comprises, optionally exclusively, a two-dimensional type camera.

In a 16^{th} aspect according to any one of the 12^{th} to 15^{th} aspects, the second sensor comprises at least one selected among: an RGB camera, an IR camera, a UV camera, a thermal camera, a single-pixel camera.

In a 17^{th} aspect according to any one of the preceding aspects, the classifier is configured to:
receive a signal representing the inspection region (V) from the control unit (4),
determine (optionally locate) the presence of people and/or specific objects in said inspection region (V), optionally emit a control signal representing the presence of people (P) and/or specific objects (C) in said inspection region (V),
   wherein the control unit (4) is configured to:
receive said control signal from the classifier,
determine—as a function of said control signal—a parameter for the detection of the presence of people (P) and/or other specific objects (C) in said inspection region (V).

In an 18^{th} aspect according to the preceding aspect, the classifier—upon receiving the signal representing the inspection region (V)—is configured to identify people (P) and/or specific objects (C) in said inspection region (V); the classifier, upon identifying people (P) and/or specific objects (C) in said inspection region (V), being optionally configured to emit said control signal.

In a 19^{th} aspect according to the preceding aspect, the control unit (4) is configured to determine an alarm situation as a function of a pre-set relationship between a pre-set detection parameter value and a reference threshold value, wherein the detection parameter comprises at least one selected from the group among: the number of people detected in the inspection region, one or more specific people detected in the inspection region, the relative position between two or more people in the inspection region, the number of specific objects in the inspection region, one or more specific objects detected in the inspection region, the type of object detected in the inspection region, the relative position between two or more objects in the inspection region, the relative position between one or more people and one or more objects in the inspection region.

In a 20^{th} aspect according to any one of the preceding aspects, the control unit (4) is configured to:
determine, optionally extract, a two-dimensional image representing the same inspection region (V) from the representation of the inspection region (V),
provide the classifier with said two-dimensional image of the inspection region (V).

In a 21^{st} aspect according to the preceding aspect, the classifier is configured to:
receive said two-dimensional image to identify people (P) and/or specific objects (C) in the same two-dimensional image,
determine (optionally locate) the presence of people and/or specific objects in said two-dimensional image, optionally emit a control signal representing the presence of people (P) and/or specific objects (C) in said two-dimensional image,
   wherein the control unit (4) is configured to:
receive said control signal from the classifier,
determine—as a function of said control signal—a parameter for the detection of the presence of people (P) and/or other specific objects (C) in said two-dimensional image representing the inspection region (V).

In a 22^{nd} aspect according to the 20^{th} or 21^{st} aspect, the classifier—upon receiving the two-dimensional image representing the inspection region (V)—is configured to identify people (P) and/or specific objects (C) in said two-dimensional image,

optionally the classifier, upon identifying people (P) and/or specific objects (C) in said two-dimensional image, being configured to emit said control signal.

In a 23^{rd} aspect according to any one of the 19^{th} to 22^{nd} aspects, the control unit is configured to:
project the representation of the inspection region (V) on a reference plane (R), optionally a virtual reference plane (R), so as to obtain said two-dimensional image of the inspection region (V),
provide the classifier with said two-dimensional image of the inspection region (V).

In a 24^{th} aspect according to any one of the preceding aspects, upon determining the inspection region (V) the control unit is configured to apply a background around the inspection region (V) so as to define said representation of the inspection region (V).

In a 25^{th} aspect according to any one of the preceding aspects, the background comprises:
an image consisting of pixels of the same colour, for example a white image,
an image representing the scene (S), optionally filtered, shot during a reference condition different from the condition during which the control unit determines said inspection region (V).

In a 26^{th} aspect according to any one of the 12^{th} to 25^{th} aspects, the second sensor (7) is configured to emit a respective monitoring signal representing the scene (S),

wherein the control unit (4) is connected to the second sensor (7) and it is configured to:
receive the respective monitoring signal from the second sensor (7),
estimate a colour two-dimensional representation of the scene (S) as a function of said respective monitoring signal,
superimpose at least part of the inspection region (V) on said colour two-dimensional representation of the same scene (S) to obtain at least one colour representation, optionally a two-dimensional representation, of the inspection region (V).

In a 27^{th} aspect according to the preceding aspect, the second sensor (7) is distinct and spaced from the first sensor (5), wherein the control unit (4) is configured to:
receive—in input—at least one calibration parameter regarding the relative position between the first sensor (5) and second sensor (7),
superimpose the inspection region and the two-dimensional representation of the scene as a function of said calibration parameter.

In a 28^{th} aspect according to any one of the 12^{th} to 27^{th} aspects, the second sensor (7) is configured to generate a colour two-dimensional image representing the scene (S) and which is formed by a pre-set number of pixels.

In a 29^{th} aspect according to the preceding aspect, the control unit (4)—as a function of the calibration parameter—is configured to associate to at least one pixel of the three-dimensional image representing the inspection region (V), at least one pixel of the colour two-dimensional image to obtain a colour estimate of the inspection region,

wherein the control unit (4) is configured to:
provide a classifier with a colour representation of the inspection region (V),
identify—optionally locate—by means of the classifier, the presence of people and/or specific objects in said inspection region (V) based on the colour representation of the inspection region (V).

In a 30^{th} aspect according to the preceding aspect, the control unit (4) is configured to:
project the representation of the colour inspection region (V) on a reference plane, optionally on a virtual reference (R), so as to obtain a colour two-dimensional image of the inspection region (V), optionally the control unit is configured to project the colour representation of the inspection region (V) on the second sensor (7) of the colour representation of the inspection region (V),
provide the classifier with said colour two-dimensional image of the inspection region (V),
   wherein the classifier is configured to:
receive a signal representing said colour two-dimensional image from the control unit (4),
determine (optionally locate) the presence of people and/or specific objects in said colour two-dimensional image, optionally emit a control signal representing the presence of people and/or specific objects in said colour two-dimensional image.

In a 31^{st} aspect according to the preceding aspect, the control unit (4) is configured to:
receive said control signal from the classifier,
determine—as a function of said control signal—a situation for the detection of the presence of people and/or specific objects in said colour two-dimensional image, optionally in the colour representation of the inspection.

In a 32^{nd} aspect according to any one of the 12^{th} to 31^{st} aspects, the second sensor (7) comprises at least one image detection camera, optionally an RGB type camera.

In a 33^{rd} aspect according to any one of the preceding aspects, the control unit (4) comprises at least one memory configured to memorise at least one classifier configured to perform steps to determine—optionally locate—the presence of people and/or specific objects in the representation of said inspection region (V).

In a 34^{th} aspect according to any one of the preceding aspects, the inspection region (V) comprises at least one selected among: a volume, a three-dimensional surface.

In a 35^{th} aspect according to any one of the preceding aspects, the inspection region (V) represents a portion of the scene (S), optionally the inspection region (V) is defined by a part of the three-dimensional representation of the scene (S).

In a 36^{th} aspect according to any one of the preceding aspects, the representation of the scene comprises at least one three-dimensional surface, wherein the inspection region (V) comprises a portion of said three-dimensional surface having a smaller extension with respect to the overall extension of said three-dimensional surface representing the entire scene.

In a 37^{th} aspect according to any one of the 25^{th} to 36^{th} aspects, the control unit (4) is configured to process the colour two-dimensional representation of the scene (S) as a function of at least one filtering parameter for extracting at least one region of interest containing at least one person and/or one specific object from the colour two-dimensional representation of the scene,

wherein said filtering parameter comprises at least one among: the position of a person identified in the two-dimensional representation of the scene, the relative position of a person identified in the two-dimensional representation of the scene with respect to another person and/or specific object, the shape of a body identified in the two-dimensional representation of the scene, the dimension of a body identified in the two-dimensional representation of the scene, the chromatic values of a body identified in the two-dimensional representation of the scene, the position of an object identified in the two-dimensional representation of the scene, the relative position of a specific object identified in the two-dimensional representation of the scene with respect to a person and/or another specific object, a specific region of interest in the two-dimensional representation of the scene S, optionally defined by means of image coordinates (values in pixels).

In a 38^{th} aspect according to the preceding aspect, the control unit (4)—upon determining the region of interest in the colour two-dimensional representation of the scene—is configured to perform the superimposition of the inspection region (V) with the region of interest so as to obtain a two-dimensional image.

In a 39^{th} aspect according to the 37^{th} or 38^{th} aspect, the second sensor (7) is configured to generate a colour two-dimensional image representing the scene (S) consisting of a pre-set number of pixels, wherein the control unit (4) is configured to generate—as a function of said filtering parameter—a segmented colour two-dimensional image defined by a plurality of pixels of the region of interest only.

In a 40^{th} aspect according to the preceding aspect, the control unit is configured to associate to at least one pixel of the three-dimensional image representing the inspection region (V), at least one pixel of the segmented colour two-dimensional image to obtain a colour estimate of the inspection region.

In a 41^{st} aspect according to the preceding aspect, the control unit (4) is configured to:
provide a classifier with a colour representation of the inspection region (V),
determine—optionally locate—by means of the classifier the presence of people and/or specific objects in said inspection region (V) based on the colour representation of the inspection region (V).

In a 42nd aspect according to any one of the preceding aspects, the control unit (4)—by means of the monitoring signal—is configured to provide the classifier with a plurality of representations per second of the inspection region (V), said plurality of representations per second of the inspection region identifying the respective time instants.

In a 43^{rd} aspect according to any one of the preceding aspects, the control unit (4) is configured to perform the step—by means of the classifier—of determining the presence of people (P) and/or specific objects (C) in the representation of said inspection region (V) on at least one of said plurality of representations per second of the inspection region (V).

In a 44th aspect according to any one of the preceding aspects, the control unit (4) comprises said classifier, optionally a neural network.

In a 45^{th} aspect a method is provided for detection by means of a detection device according to any one of the 1st to the 44^{th} aspects, said method comprising the following steps:
monitoring the scene by means of at least one sensor, the sensor—during the monitoring step—emitting at least one monitoring signal representing the scene.
sending said monitoring signal to the control unit (4) which is configured to:
   receive the monitoring signal from the sensor,
   estimate a three-dimensional representation of the scene (S) as a function of said monitoring signal,
   extract at least one inspection region (V) from the three-dimensional representation of the scene,
   provide a classifier with a representation of the inspection region (V),
   determine, optionally locate—by means of the classifier—the presence of people (P) and/or specific objects (C) in the representation of said inspection region (V).

In a 46^{th} aspect according to the preceding aspect, upon receipt of the representation of the inspection region (V) by the control unit, the classifier carries out the following steps:
it identifies people (P) and/or specific objects (C) in the inspection region (V),
it determines the presence of people (P) and/or specific objects (C) in said inspection region (V), it optionally emits a control signal representing the presence of people (P) and/or specific objects (C) in said inspection region (V),
optionally it sends the control signal to the control unit designated to determine the presence of people (P) and/or specific objects (C) in the representation of said inspection region (V).

In a 47^{th} aspect according to any one of the preceding aspects, the inspection region comprises:
a three-dimensional image, optionally a colour image, representing at least one part of the scene,
a two-dimensional image, optionally a colour image, representing at least one part of the scene.

In a 48^{th} aspect a detection device (1) is provided for, comprising:
at least one sensor configured to emit at least one monitoring signal representing a scene (S),
a control unit (4) connected to said sensor and configured to:
   receive the monitoring signal from the sensor,
   estimate a two-dimensional representation of the scene (S) as a function of said monitoring signal,
   estimate at least one three-dimensional information of the scene (S) as a function of said monitoring signal,
   provide at least one classifier with said two-dimensional representation of the scene (S),
   determine—by means of the classifier—the presence of people (P) and/or specific objects (C) in the two-dimensional representation of the scene (S),
   define at least one control region containing at least part of at least one person and/or specific object (C) whose presence was determined, in the two-dimensional representation of the scene (S), by means of the classifier,
   allocate the three-dimensional information to said control region (T),
   as a function of a pre-set relationship between the three-dimensional information allocated to said control region (T) and a three-dimensional reference parameter, define at least one inspection region (V) from said control region.

In a 49^{th} aspect according to any one of the preceding aspects, the control unit (4)—as a function of the monitoring signal—is configured to estimate a three-dimensional representation of the scene (S), wherein the control unit (4) is configured to define, optionally extract, the three-dimensional information from said three-dimensional representation of the scene (S), optionally the three-dimensional representation of the scene (S) comprises the three-dimensional information.

In a 50^{th} aspect according to any one of the preceding aspects, the control unit (4)—as a function of said monitoring signal—is configured to generate a cloud of points (N) suitable to estimate the three-dimensional representation of the scene (S).

In a 50^{th} aspect according to any one of the preceding aspects, the three-dimensional representation of the scene comprises a three-dimensional image, optionally a depth map, consisting of a pre-set number of pixels.

In a 52^{th} aspect according to any one of the preceding aspects, each pixel—of at least part of said pre-set number of pixels of the three-dimensional image—comprises the three-dimensional information of the scene.

In a 53^{rd} aspect according to any one of the 47^{th} to 52^{nd} aspects, the three-dimensional information comprises at least one among:
a relative position of each pixel with respect to a pre-set reference system,
a relative position of a first pixel representing a first body, for example a person and/or an object, with respect to a second pixel representing a second body, for example a person and/or an object,
a shape of at least one body, for example a person and/or an object, defined by one or more pixels of the three-dimensional image,
a dimension of at least one body, for example a person and/or an object, defined by one or more pixels of the three-dimensional image,
chromatic values of each pixel.

In a 54^{th} aspect according to the preceding aspect, the relative position of the three-dimensional information of each pixel comprises at least one among:
a distance, in particular a minimum distance, of said pixel from an origin defined by means of spatial coordinates of a three-dimensional Cartesian reference system,
a distance, in particular minimum distance, of said pixel from an origin defined by means of polar coordinates of a cylindrical coordinate reference system,
a distance, in particular minimum distance, of said pixel from an origin defined by means of polar coordinates of a spherical coordinate reference system,

In a 55^{th} aspect according to any one of the 47^{th} to 54^{th} aspects, the control unit (4)—during the step of allocating said three-dimensional information to said control region (T)—is configured to allocate the three-dimensional information of at least one pixel of the three-dimensional image to the control region (T).

In a 56^{th} aspect according to any one of the 47^{th} to 55^{th} aspects, the control region is defined by a portion of the two-dimensional representation of the scene (S).

In a 57^{th} aspect according to any one of the 47^{th} to 56^{th} aspects, the control region has a smaller pre-set surface extension with respect to an overall surface extension of the two-dimensional representation of the scene (S).

In a 58^{th} aspect according to any one of the 47^{th} to 57^{th} aspects, the two-dimensional representation of the scene comprises a two-dimensional image, optionally a colour image, consisting of a plurality of pixels.

In a 59^{th} aspect according to the preceding aspect, the control region is defined by a pre-set number of pixels of said plurality, optionally the pre-set number of pixels of the control region is smaller than the overall number of the plurality of pixels of the two-dimensional image.

In a 60^{th} aspect according to the preceding aspect, the control unit (4) is configured to allocate the three-dimensional information of at least one pixel of the three-dimensional image to at least one respective pixel of the control region.

In a 61^{st} aspect according to the 58^{th} or 59^{th} or 60^{th} aspect, the control unit (4) is configured to allocate, to each pixel of the control region, the three-dimensional information of a respective pixel of the three-dimensional image.

In a 62^{nd} aspect according to any one of the 58^{th} to 61^{st} aspects, the control unit (4)—during the step of defining the inspection region (V)—is configured to:
compare a value of the three-dimensional information of at least one pixel of the control region with at least one value of the three-dimensional reference parameter,
following said comparison step, defining the inspection region (V) as a function of a pre-set relationship between at least one value of said three-dimensional information and the value of the three-dimensional reference parameter.

In a 63^{rd} aspect according to the preceding aspect, said pre-set relationship is a difference between the value of the three-dimensional information of at least one pixel of the control region representing a position of said pixel in the space and at least the reference parameter value.

In a 64^{th} aspect according to the 61^{st} or 62^{nd} or 63^{rd} aspect, the control unit (4) is configured to:
Exclude at least one portion of said control region from the inspection region in case the value of the three-dimensional information of said portion of the control region differs from the value of the three-dimensional reference parameter exceeding a pre-set threshold,
associate at least one portion of the control region to said inspection region (V) in case the value of the three-dimensional information of said portion of the control region differs from the value of the three-dimensional reference parameter within the limits of the pre-set threshold.

In a 65^{th} aspect according to any one of the preceding aspects, the control unit (4) is configured to determine a detection parameter relative to the presence of people (P) and/or specific objects (C) in said inspection region (V).

and wherein the control unit (4) is configured to determine an alarm situation as a function of a pre-set relationship between a value of the pre-set detection parameter and a value of a reference threshold.

In a 66^{th} aspect according to the preceding aspect, the detection parameter comprises at least one among: the number of people detected in the inspection region, one or more specific people detected in the inspection region, the relative position between two or more people in the inspection region, one or more specific objects detected in the inspection region, the number of specific objects in the inspection region, the type of object detected in the inspection region, the relative position between two or more objects in the inspection region, the relative position between one or more people and one or more objects in the inspection region.

In a 67^{th} aspect according to any one of the preceding aspects, the classifier is configured to identify, optionally locate, people and/or objects in the two-dimensional image representation of the scene (S).

In a 68^{th} aspect according to any one of the preceding aspects, the classifier is configured to identify the position of people and/or objects in the two-dimensional image representation of the scene (S).

In a 69^{th} aspect according to any one of the preceding aspects, the at least one sensor comprises at least one among: an RGB-D camera, at least two two-dimensional cameras (optionally at least one RGB camera), a two-dimensional camera (optionality an RGB camera), a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 70^{th} aspect according to any one of the preceding aspects, the device comprises at least one first sensor (5) and at least one second sensor (7) distinct from each other.

In a 71^{st} aspect according to the preceding aspect, the first sensor (5) exclusively comprises a three-dimensional type camera

In a 72^{nd} aspect according to the 69^{th} or 70^{th} or 71^{st} aspect, the first sensor comprises at least one among: a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 73^{rd} aspect according to any one of the 69^{th} to 72^{nd} aspects, the second sensor (5) is configured to generate a monitoring signal, the control unit (4) is configured to:
receive the monitoring signal from the first sensor (5),
define the three-dimensional information, optionally estimate the three-dimensional representation of the scene (S) from which the three-dimensional information of the scene will then be extracted as a function of said monitoring signal received from the first sensor.

In a 74^{th} aspect according to any one of the 69^{th} to 73^{rd} aspects, the second sensor (7) exclusively comprises a two-dimensional type camera.

In a 75^{th} aspect according to any one of the 69^{th} to 74^{th} aspects, the second sensor comprises at least one selected among: an RGB camera, an IR camera, a UV camera, a thermal camera, a single-pixel camera.

In a 76^{th} aspect according to any one of the 69^{th} to 75^{th} aspects, the second sensor (7) is configured to generate a respective monitoring signal, the control unit (4) is configured to:
receive the respective monitoring signal from the second sensor (7),
estimate the two-dimensional representation of the scene (S) as a function of said monitoring signal received from the second sensor (7),

In a 77^{th} aspect according to any one of the 47^{th} to 76^{th} aspects, the control unit (4)—during the step of allocating the three-dimensional information to said control region (T)—is configured to superimpose the representation of the three-dimensional image comprising at least one three-dimensional information to the control region.

In a 78^{th} aspect according to the preceding aspect, the first and the second sensor (7) are distinct and spaced from each other, wherein the control unit (4) is configured to:
receive—in input—at least one calibration parameter regarding the relative position between the first sensor (5) and second sensor (7),
superimpose the control region and the three-dimensional representation of the scene as a function of said calibration parameter.

In a 79^{th} aspect according to any one of the preceding aspects, the control unit (4) comprises at least one memory configured to memorise at least one classifier configured to determine—optionally locate—the presence of people and/or specific objects in the two-dimensional representation of the scene (S).

In an 80^{th} aspect according to any one of the preceding aspects, the three-dimensional representation of the scene comprises at least one three-dimensional surface, wherein the inspection region (V) comprises a portion of said three-dimensional surface having a smaller extension with respect to the overall extension of said three-dimensional surface representing the entire scene.

In an 81^{st} aspect according to any one of the preceding aspects, the control unit (4) is configured to process the two-dimensional representation of the scene (S) as a function of at least one filtering parameter to define at least one filtered two-dimensional representation of the scene (S).

In an 82^{nd} aspect according to the preceding aspect, the filtering parameter comprises at least one among:
the position of a person identified in the two-dimensional representation of the scene,
the relative position of a person identified in the two-dimensional representation of the scene with respect to another person and/or specific object,
the shape of a body identified in the two-dimensional representation of the scene,
the dimension of a body identified in the two-dimensional representation of the scene,
the chromatic values of a body identified in the two-dimensional representation of the scene,
the position of an object identified in the two-dimensional representation of the scene,
the relative position of a specific object identified in the two-dimensional representation of the scene with respect to a person and/or another specific object,
a pre-set region of interest in the two-dimensional representation of the scene S, optionally defined by means of image coordinates (values in pixels). In detail, such filter provides for cutting out a pre-set region of the two-dimensional representation of the scene S so as to exclude regions of no interest for the classifier a priori.

In an 83^{rd} according to the 80^{th} or 81^{st} or 82^{nd} aspect, the control unit (4) is configured to send, to the classifier, said filtered two-dimensional representation of the scene (S), the control unit (4) is optionally configured to define the control region (T) in the filtered two-dimensional representation of the scene (S).

In an 84^{th} aspect according to any one of the preceding aspects, the control unit (4) is configured to define a plurality of inspection regions per second, each of which representing at least one part of the scene in a respective time instant.

In an 85^{th} aspect a method is provided for detection by means of a detection device according to any one of the preceding aspects, said method comprising the following steps:
monitoring the scene by means of at least one sensor, the sensor—during the monitoring step—emitting at least one monitoring signal representing the scene.
sending said monitoring signal to the control unit (4) which is configured to:
   receive the monitoring signal from the sensor,
   estimate a two-dimensional representation of the scene (S) as a function of said monitoring signal,
   estimate at least one three-dimensional information of the scene (S) as a function of said monitoring signal,
   provide at least one classifier with said two-dimensional representation of the scene (S),
   determine—by means of the classifier—the presence of people (P) and/or specific objects (C) in the two-dimensional representation of the scene (S),
   define at least one control region containing at least part of at least one person and/or specific object (C) whose presence was determined, in the two-dimensional representation of the scene (S), by means of the classifier,
   allocate the three-dimensional information to said control region (T),
   define at least one inspection region (V) from said control region as a function of a pre-set relationship between the three-dimensional information allocated to said control region (T) and a three-dimensional reference parameter.

In an 86^{th} aspect according to the preceding aspect, the method comprises the following steps:
determining—by means of a control unit—a detection parameter relative to the presence of people (P) and/or specific objects (C) in said inspection region (V),
determining an alarm situation as a function of a pre-set relationship between a pre-set detection parameter value and a reference threshold value,
   wherein the detection parameter comprises at least one among:
the number of people detected in the inspection region, one or more specific people detected in the inspection region, the relative position between two or more people in the inspection region, one or more specific objects detected in the region of interest, the number of specific objects in the inspection region, the type of object detected in the inspection region, the relative position between two or more objects in the inspection region, the relative position between one or more people and one or more objects in the inspection region.

In an 87^{th} aspect a detection device (1) is provided for, comprising:
at least one sensor (5) configured to emit at least one monitoring signal representing a scene (S) seen from a first observation point,
at least one second sensor (7) distinct and spaced from the first sensor, said second sensor being configured to emit a respective monitoring signal representing the same scene (S) seen from a second observation point different from the first observation point,
a control unit (4) connected to said first and second sensor, said control unit (4) being configured to:
   receive the monitoring signal from the first sensor,
   receive the respective monitoring signal from the second sensor,
   estimate at least one three-dimensional representation of the scene (S) as a function of the monitoring signal respectively of the first sensor and of the second sensor,
   provide a classifier with at least one image, representing the three-dimensional representation of the scene,
   determine—by means of the classifier—the presence of people (P) and/or specific objects in said image.

In an 88^{th} aspect according to any one of the preceding aspects, the control unit is configured to project the three-dimensional representation of the scene (S) at least on a first reference plane, optionally a virtual reference plane, to define said image, said image being a two-dimensional representation of the scene seen from a third observation point.

In an 89^{th} aspect according to the preceding aspect, the third observation point is distinct from at least one selected among the first and the second observation point of the scene.

In a 90^{th} aspect according to any one of the preceding aspects, the three-dimensional representation of the scene (S) comprises at least one cloud of points (N).

In a 91^{st} aspect according to any one of the preceding aspects, the three-dimensional representation of the scene comprises a three-dimensional image, optionally a depth map, consisting of a pre-set number of pixels.

In a 92^{nd} aspect according to the preceding aspect, the control unit (4) is configured to allocate to each pixel of the three-dimensional image—of at least part of said pre-set number of pixels—an identification parameter, optionally representing a position of said pixel in the space with respect to a pre-set reference system.

In a 93^{rd} aspect according to the preceding aspect, said identification parameter of each pixel further comprises at least one selected in the group among:
a distance, in particular a minimum distance, of said pixel from an origin defined by means of spatial coordinates of a three-dimensional Cartesian reference system,
a distance, in particular minimum distance, of said pixel from an origin defined by means of polar coordinates of a cylindrical coordinate reference system,
a distance, in particular minimum distance, of said pixel from an origin defined by means of polar coordinates of a spherical coordinate reference system,

In a 94^{th} aspect according to any one of the preceding aspects, the control unit (4) is configured to:
determine, optionally extract, an inspection region (V) from the three-dimensional representation of the scene,
project a representation of the inspection region (V) on the at least one reference plane (R), optionally a virtual reference plane, so as to obtain the two-dimensional representation of the scene (S).

In a 95^{th} aspect according to any one of the preceding aspects, the control unit (4)—during the step of determining the inspection region (V)—is configured to:
compare a value of the identification parameter of at least one pixel of the three-dimensional image—of at least one part of said pre-set number of pixels—with at least one reference parameter value,
following said comparison step, define the inspection region (V) as a function of a pre-set relationship between at least one reference parameter value and the identification parameter value of the pixels of the three-dimensional image of at least part of said pre-set number, optionally said pre-set relationship being a difference between at least one reference parameter value and the identification parameter value of the pixels of the three-dimensional image of at least part of said pre-set number.

In a 96^{th} aspect according to the preceding aspect, the reference parameter comprising at least one among:
A relative position of each pixel with respect to a pre-set reference system, optionally a plurality of reference values relative to spatial coordinates of a virtual region representing the inspection region (V),
a relative position of a first pixel representing a first body, for example a person and/or an object, with respect to a second pixel representing a second body, for example a person and/or an object,
a shape of at least one body, for example a person and/or an object, defined by one or more pixels of the three-dimensional image,
a dimension of at least one body, for example a person and/or an object, defined by one or more pixels of the three-dimensional image,
chromatic values of each pixel.

In a 97^{th} aspect according to the 94^{th} or 95^{th} or 96^{th} aspect, the reference parameter comprises a plurality of reference values regarding spatial coordinates of a virtual region representing the inspection region (V).

In a 98^{th} aspect according to any one of the preceding aspects, the control unit (4) is configured to determine a detection parameter relative to the presence of people (P) and/or specific objects (C) in the two-dimensional representation of the scene (S), optionally in the inspection region.

In a 99^{th} aspect according to the preceding aspect, wherein the control unit (4) is configured to determine an alarm situation as a function of a pre-set relationship between a pre-set detection parameter value and a reference threshold value,

wherein the detection parameter comprises at least one among:
the number of people detected in the inspection region, one or more specific people detected in the inspection region, the relative position between two or more people in the inspection region, the number of specific objects in the inspection region, the type of object detected in the inspection region, the relative position between two or more objects in the inspection region, the relative position between one or more people and one or more objects in the inspection region.

In a 100^{th} aspect according to any one of the 86^{th} to the 99^{th} aspects, the first sensor (5) comprises at least one among: an RGB-D camera, an RGB camera, a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 101^{st} aspect according to any one of the 86^{th} to the 100^{th} aspects, the second sensor (7) comprises at least one among: an RGB-D camera, an RGB camera, a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

In a 102^{nd} aspect according to any one of the 86^{th} to 101^{st} aspects, the control unit (4) is configured to:
estimate at least one three-dimensional representation of the scene (S) seen from a first observation point as a function of the monitoring signal of the first sensor,
estimate at least one three-dimensional representation of the scene (S) seen from a second observation point as a function of the monitoring signal of the first sensor,
superimpose the three-dimensional representations of the scene estimated respectively as a function of the monitoring signal of the first and second sensor to form a single three-dimensional image,
projecting said three-dimensional image at least on a virtual reference plane so as to estimate at least one two-dimensional representation of the scene (S) seen from a third observation point of the scene.

In a 103^{rd} aspect according to the preceding aspect, the three-dimensional image comprises a depth map, consisting of a pre-set number of pixels.

In a 104^{th} aspect according to the preceding aspect, the control unit (4) is configured to allocate to each pixel of the three-dimensional image—of at least part of said pre-set number of pixels—said identification parameter, optionally representing a position of said pixel in the space with respect to pre-set reference system.

In a 105^{th} aspect according to any one of the 86^{th} to 104^{th} aspects, the first sensor (5) comprises an RGB-D camera, wherein the second sensor (7) comprises a respective RGB-D camera, the control unit (4) is configured to:
receive the monitoring signal from the first sensor,
generate a colour cloud of points defining the colour three-dimensional representation of the scene seen from a first observation point,
receive the monitoring signal from the second sensor,
generate a colour cloud of points defining the colour three-dimensional representation of the scene seen from a second observation point,
superimpose said colour three-dimensional representations of the scene estimated respectively as a function of the monitoring signal of the first and second sensor to form a single colour three-dimensional image of the scene (S),
project said colour three-dimensional image of the scene (S) at least on a virtual reference plane, optionally a virtual reference plane, so as to estimate at least one colour two-dimensional representation of the scene (S) seen from a third observation point of the scene.

In a 106^{th} aspect according to any one of the 86^{th} to 105^{th} aspects, the control unit (4) is configured to process the two-dimensional representation of the scene (S), optionally of the colour type, as a function of at least one filtering parameter for extracting at least one region of interest containing at least one person and/or one specific object, wherein said filtering parameter comprises at least one among:
the position of a person identified in the two-dimensional representation of the scene,
the relative position of a person identified in the two-dimensional representation of the scene with respect to another person and/or specific object,
the shape of a body identified in the two-dimensional representation of the scene,
the dimension of a body identified in the two-dimensional representation of the scene,
the chromatic values of a body identified in the two-dimensional representation of the scene,
the position of an object identified in the two-dimensional representation of the scene,
the relative position of a specific object identified in the two-dimensional representation of the scene with respect to a person and/or another specific object,
a pre-set region of interest in the two-dimensional representation of the scene, optionally defined by means of image coordinates (values in pixels). In detail, such filter provides for cutting out a pre-set region of the two-dimensional representation of the scene S so as to exclude regions of no interest for the classifier a priori.

In a 107^{th} aspect according to the preceding aspect, the control unit (4) is configured to determine a detection parameter relative to the presence of people (P) and/or specific objects in the region of interest,

wherein the control unit (4) is configured to determine an alarm situation as a function of a pre-set relationship between a value of the pre-set detection parameter and a value of a reference threshold,
wherein the detection parameter comprises at least one among: the number of people detected in the region of interest, one or more specific people detected in the region of interest, the relative position between two or more people in the region of interest, the number of specific objects in the region of interest, one or more specific objects in the region of interest, the type of object detected in the region of interest, the relative position between two or more objects in the region of interest, the relative position between one or more people and one or more objects in the region of interest.

In a 108^{th} aspect according to any one of the preceding aspects, the classifier, upon receipt of the three-dimensional representation of the scene, is configured to:
identify people (P) and/or specific objects (C) in said image,
determine the presence of people (P) and/or specific objects (C) in said image, optionally emit a control signal representing the presence of people (P) and/or specific objects (C) in said image,
optionally send the control signal to the control unit designated to determine the presence of people (P) and/or specific objects (C) in said image.

In a 109^{th} aspect according to any one of the 86^{th} to 108^{th} aspects, the image representing the three-dimensional representation of the scene comprises a two-dimensional image, optionally a colour image, or a three-dimensional image, optionally a colour image.

In a 110^{th} aspect a method is provided for detection by means of a detection device according to any one of the preceding aspects, said method comprising the following steps:
monitoring the scene by means of at least the first and second sensor, the sensors—during the monitoring step —respectively emit at least one monitoring signal representing the scene (S).
sending the monitoring signals respectively of the first and second sensor to the control unit (4) which is configured to:
   estimate at least one three-dimensional representation of the scene (S) as a function of at least one among the monitoring signal of the first sensor and the monitoring signal of the second sensor,
   provide a classifier with at least one image, representing the three-dimensional representation of the scene,
   determine—by means of the classifier—the presence of people (P) and/or specific objects in said image.

In a 111^{th} aspect according to the preceding aspect, said image is a two-dimensional representation of the scene seen from a third observation point and it is obtained by projecting the three-dimensional representation of the scene (S) at least on one virtual reference plane,

wherein the third observation point is distinct from at least one selected among the first and the second observation point of the scene.

In a 112^{th} aspect a use of the detection device (1) is provided for, according to any one of the preceding aspects for detecting people and/or specific objects in a scene, optionally said detection device (1) can be used for:
recognising people and/or animals and/or specific objects on conveyor belts in airports,
recognising people in critical areas due to safety reasons,
recognising the type of baggage in an automatic check-in system,
recognising the passing through of more than one person in double doors, revolving doors, entrances,
recognising dangerous objects in double doors, revolving doors, entrances,
recognising the type of packages on conveyor belts and/or roller units, for example separators and sorters, in the logistics/postal industries,
morphological analysis of pallets in the logistics industry,
recognition of people in airport waiting areas, for example baggage collection carousels, so as to customise advertising messages,
postural analysis in human/machine interaction to identify dangerous conditions for human beings and/or prevention of injuries,
dimensional and/or colorimetric evaluation in the live and/or slaughtered animals food industry,
dimensional e/o colorimetric evaluation in the fruits and vegetables food industry.

### BRIEF DESCRIPTION OF THE DRAWINGS

Some embodiments and some aspects of the invention will be described hereinafter with reference to the attached drawings, provided solely by way of non-limiting example, wherein:

FIG. 1 is a schematisation of a detection device according to the present invention in use to evaluate a pre-set scene;

FIGS. 2 and 3 are representations of the pre-set scene that can be generated by the detection device according to the present invention;

FIG. 4 is a top view of a detection device according to the present invention;

FIG. 5 is a schematic representation of the scene in front view;

FIGS. 6 and 7 schematically show an inspection region that can be extracted from the scene by the detection device;

FIG. 8 is a schematic representation of a control region that can be generated by the control device representing a portion of a scene;

FIG. 9 is a schematisation of an inspection region that can be extracted from the control region by a detection device according to the present invention;

FIGS. 10-12 are schematic representations of a detection device according to the present invention in use on a check-in station for evaluating a further scene;

FIGS. 13 and 14 are representations of further scenes that can be generated by the detection device according to FIGS. 10-12;

FIGS. 15 and 16 show an inspection region that can be extracted by the detection device according to FIGS. 10-12;

FIG. 17 is a schematisation of a further detection device according to the present invention for evaluating a pre-set scene;

FIG. 18 shows a representation that can be generated by the detection device according to FIG. 17;

FIG. 19 schematically shows an inspection region that can be extracted by the detection device according to FIG. 17;

FIG. 20 is a schematic representation of a control region that can be generated by the control device according to FIG. 17, representing a portion of a scene;

FIG. 21 is a schematisation of an inspection region that can be extracted from the control region by a detection device according to FIG. 17;

FIG. 22 is a top view of a detection device according to FIG. 17.

### CONVENTIONS

It should be observed that in the present detailed description, corresponding parts illustrated in the various figures are indicated using the same reference numbers. The figures could illustrate the object of the invention using non-full-scale representations; thus, parts and components illustrated in the figures regarding the object of the invention could exclusively regard schematic representations.

### Definitions

The term article L could be used to indicate a baggage, a bag, a package, a load, or an element with similar structure and function. Thus, the article can be made of any type of material and be of any shape and size.

The term object could be used to indicate at least one or more objects of any kind, shape and size.

The term person is used to indicate one or more portions of a subject, for example a subject passing in proximity of the detection device, for example a user utilising the check-in station, or an operator designated to oversee the operation of the check-in station or a subject passing in proximity of the check-in station.

The term field of view is used to indicate the scene perceivable by a sensor, for example an optical sensor, from a point in the space. The term scene is used to indicate the total space shot by one or more sensors or by the combination thereof.

The term representation of the scene S is used to indicate a processing, in particular an analogue or digital processing of the actual scene carried out by a control unit. A representation of the scene can be defined by a two-dimensional or three-dimensional surface. A representation of the scene can also be defined by a three-dimensional volume. In particular, according to a preferred embodiment of the invention, the representation of the scene obtained by means of a three-dimensional sensor or the three-dimensional representation of the scene obtained through a plurality of two-dimensional sensors defines a three-dimensional surface. The three-dimensional surface defining the representation of the scene defines a three-dimensional volume of the scene around itself.

The term two-dimensional sensor or 2D sensor is used to indicate a sensor capable of providing a signal representing a two-dimensional image, in particular of an image wherein an information regarding the position thereof on a two-dimensional plane corresponds to each pixel.

The term three-dimensional sensor or 3D sensor is used to indicate a sensor capable of providing a signal representing a three-dimensional image, in particular of an image wherein an information regarding the position thereof on a two-dimensional plane and along the depth plane corresponds to each pixel. In particular, the term three-dimensional sensor or 3D sensor is used to indicate a sensor capable of providing a depth map of the scene S.

The term region is used to indicate a two-dimensional or three-dimensional space portion. For example, a region may comprise: a two-dimensional surface, a three-dimensional surface, a volume, a representation of a volume. In particular, the term region is used to indicate the whole or a portion of the 2D or 3D representation of the scene of the volume comprising the 2D or 3D surface of the representation of the scene.

The detection device 1 described and claimed herein comprises at least one control unit 4 designated to control the operations carried out by the detection device 1. The control unit 4 may clearly be only one or be formed by a plurality of distinct control units depending on the design choice and operative needs. The term control unit is used to indicate an electronic type component which may comprise at least one among a digital processor (for example one among: a CPU, a GPU, a GPGPU), a memory (or memories), an analogue circuit, or a combination of one or more digital processing units with one or more analogue circuits. The control unit can be “configured” or “programmed” to perform some steps: this can practically be obtained using any means capable of enabling to configure or programme the control unit. For example, should the control unit comprise one or more CPUs and/or one or more GPUs and one or more memories, one or more programmes can be memorised in appropriate memory banks connected to the CPU or to the GPU; the programme or programmes contain instructions which, when executed by one or more CPUs or by one or more GPUs, programme and configure the control unit to perform the operations described regarding the control unit. Alternatively, if the control unit is or comprises an analogue circuit, then the circuit of the control unit can be designed to include a circuit configured, in use, to process electrical signals so as to perform the steps relative to the control unit.

The control unit may comprise one or more digital units, for example of the microprocessor type, or one or more analogue units, or an appropriate combination of digital and analogue units; the control unit can be configured to coordinate all actions required to perform an instruction and sets of instructions.

The term classifier is used to indicate a mapping from a space (discrete or continuous) of characteristics to a set of tags. A classifier can be pre-set (based on knowledge a priori) or based on automatic learning; the latter type of classifiers are divided into supervised and non-supervised, depending on whether they use a set of training to learn the classification model (definition of the classes) or not. Neural networks, for example based on automatic learning, are examples of classifiers. The classifier can be integrated in the control unit.

### DETAILED DESCRIPTION

### 1. Detection Device

A device 1 for detecting people P and/or objects of various types—such as for example baggage, packages, bags, paper bags—present in a scene S is indicated in its entirety with 1. The detection device 1, as better described hereinafter, may be used in the transportation industry (for example airports) for analysing and recognising people and/or objects in critical areas, for example an airport check-in area and/or the technical area of an airport separated from the public area. The detection device 1 can also be used in the logistics industry for analysing and recognising an object for the correct classification thereof; the detection device 1 can also be applied to security systems for identifying fraudulent access attempts by people across control areas, for example anti-piggybacking and/or anti-tailgating solutions. The detection device 1 can also be used in the airport industry for recognising—at conveyor belts—people and/or animals and/or baggage and/or objects part of a predetermined category, for example with the aim of signalling the presence of people in critical areas for security reasons or with the aim of sorting baggage and/or objects according to the category they belong to. The detection device 1 may be configured to perform the recognition of the type of baggage in an airport automatic check-in system (self bag drop), for example detecting the shape, weight, rigid or flexible structure thereof. Furthermore, the invention can be configured to carry out the recognition of dangerous objects (pistols, knives, etc.), the type of packages on the conveyor belts and/or roller units, separators and sorters in the logistics/postal industry and analysing the morphology of pallets in the logistics industry.

Furthermore, it can be used for recognising the age and/or gender of the people in the airport waiting area for example at the baggage transfer and collection belts) so as to customise advertising messages.

Furthermore, the detection device 1 may be used for postural analysis in the human/machine interactions and/or injury prevention and/or wellness, in the food industry for dimensional and/or colorimetric analysis of live or slaughtered animals, fruits and vegetables.

Described below are possible fields of application of the detection device 1 including the use thereof in a narrow access area, in a baggage check-in station in airports and in a rotating automatic doors access station.

### 1.1 First Embodiment of the Detection Device 1

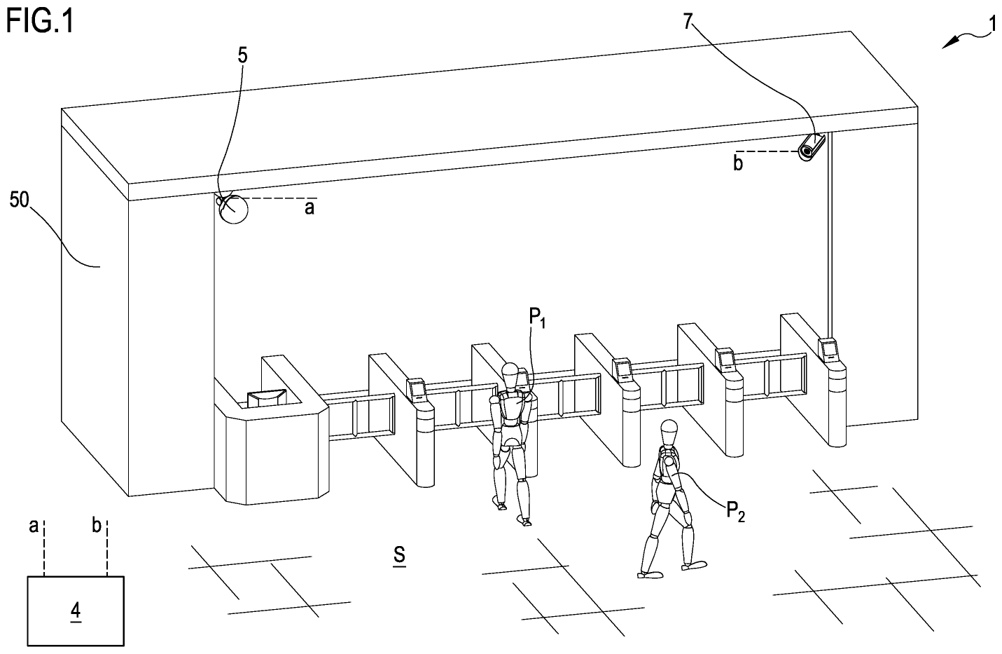

The Detection Device 1 Comprises at Least One Sensor Configured to Monitor a Scene S and Optionally to Emit a monitoring signal representing the same scene S. Schematised in FIG. 1 is a condition wherein the sensor is carried by a fixed support structure 50 delimiting a crossing area for one or more subjects or people P. The scene S (FIG. 1) is represented by anything capable of detecting (seeing) the sensor at the crossing area: thus, the scene S is defined by the field of view of the sensor. From a structural point of view, the sensor comprises at least one 3D camera and/or one 2D camera. For example, the sensor comprises at least one from among: an RGB camera, an RGB-D camera, a 3D light field camera, an infrared camera, (optionally an infrared-ray depth dual sensor consisting of an infrared projector and a camera sensitive to the same band), an IR camera, a UV camera, a laser camera (optionally a 3D laser scanner), a time-of-flight camera, a structured light optical measuring system, a stereoscopic system, a single-pixel camera, a thermal camera.

Generally, this type of sensors enables reconstructing the positioning of objects in the space (scene S) in the two-dimensional and/or three-dimensional arrangement thereof, with or without chromatic information. For example, a three-dimensional sensor or two or more two-dimensional sensors enable generating a three-dimensional representation of the scene.

The device 1 comprises a first sensor 5 and a second sensor 7 distinct from each other. The first sensor 5 exclusively comprises a 3D camera with the aim of providing a three-dimensional representation of the scene S. The sensor 5 can be a 3D light field camera, a 3D laser scanner camera, a time-of-flight camera, a structured light optical measuring system, a stereoscopic system (consisting of RGB and/or IR and/or UV cameras and/or thermal cameras and/or single-pixel camera). The sensor 5 can be an infrared camera having an infrared projector and a camera sensitive to the same frequency band.

The second sensor 7 exclusively comprises a 2D camera, monochromatic (or of the narrow-band type in any case and not necessarily in the visible spectrum) or providing the chromatic characteristics of the scene S. For example, the second sensor 7 is a 2D RGB camera. The second sensor 7 may alternatively comprise a UV camera, an infrared camera, a thermal camera, a single-pixel camera. The second sensor 7 (shown in FIG. 1) is thus configured to emit a signal representing the scene S, providing a colour two-dimensional representation of the latter. The colour image of the second sensor is essentially used for colouring the general three-dimensional representation by means of the first sensor. The sensor 7 comprising the 2D RGB camera provides a higher two-dimensional resolution—i.e. the degree of quality of an image in terms of number of pixels per inch—with respect to the first three-dimensional sensor 5; thus, the second sensor 7 enables obtaining a clearer and more detailed colour two-dimensional image representing the scene S with respect to the one obtained by the first sensor 5 providing a three-dimensional representation.

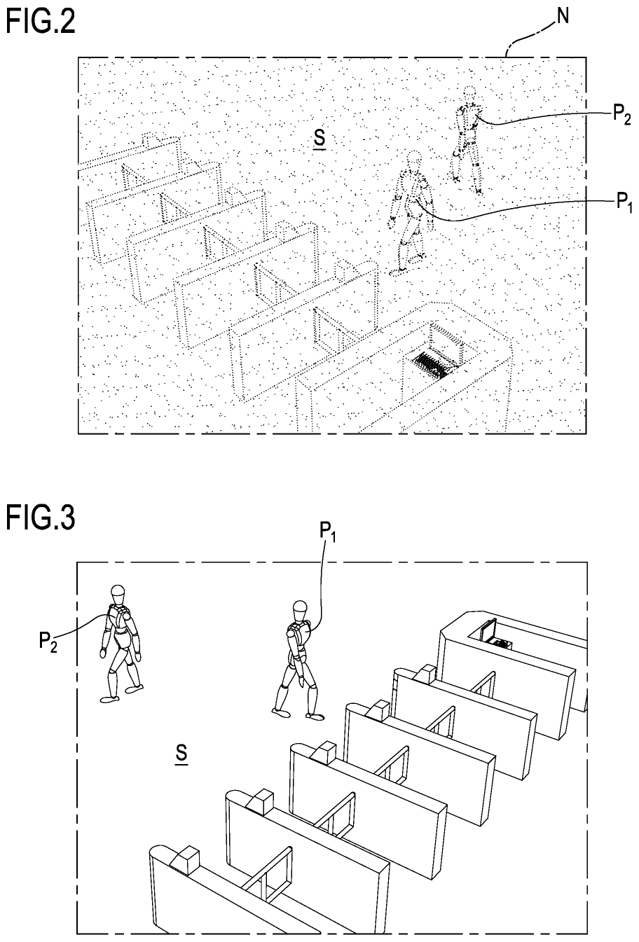

The detection device 1 comprises a control unit 4 (FIG. 1) connected to the sensor, optionally to the first and the second sensor, configured to receive the monitoring signal from the latter (or from both sensors 5 and 7), as a function of which the control unit is configured to estimate the three-dimensional representation of the scene S. In detail, the control unit 4 is configured to estimate a three-dimensional representation of the scene S as a function of the monitoring signal, defining a cloud of points N shown in FIG. 2. The estimate of the three-dimensional representation of the scene S can be obtained starting from at least one 3D sensor, for example the first sensor 5, or by at least two 2D sensors, for example at least two second sensors 7. The cloud of points N defines the pixels, and thus the spatial resolution, of the three-dimensional representation of the scene S, thus the control unit 4 is configured to allocate to each pixel—or at least part of the pre-set number of pixels—an identification parameter representing a position of said pixel in the space with respect to a pre-set reference system. The aforementioned identification parameter of each pixel comprises a distance, optionally a minimum distance, of the pixel from an origin defined by means of spatial coordinates of a three-dimensional Cartesian reference system, alternatively of a cylindrical coordinate reference system or by means of polar coordinates of a spherical coordinate reference system.

In other words, exploiting the data coming from the first sensor 5, the control unit 4 can substantially calculate, optionally in real time, the depth map of the scene S, i.e. a representation of the scene S wherein the distance from the camera, i.e. the spatial coordinates, is associated to each pixel. The calculation of the depth map can be carried out directly by the first three-dimensional sensor 5 or, alternatively, by processing at least two 2D images of the second sensor 7 by means of the control unit 4. In other words, the control unit 4, due to the use of the sensor 5, can recognise the three-dimensional positioning in the scene S, pixel by pixel.

A possible method for obtaining the depth map exploits the structured light method wherein a known pattern is projected on the scene and the distance of each pixel is estimated based on the deformations taken by the pattern. Still alternatively (or combined to improve the detail and/or accuracy of the reconstruction), the principle according to which the degree of blurriness depends on the distance, can be exploited. In a further alternative, the depth map can be obtained by means of time-of-flight image processing techniques. Special lenses with different focal length values in X and Y can be used. For example, by projecting circles, the same deform in an ellipsis whose orientation depends on the depth. The stereoscopic vision also enables to estimate the depth by observing the same region of inspection from two different points. The difference in the position of the corresponding points (disparity) in the two reconstructed images is bound to the distance that can be calculated using trigonometric calculations.

In a common embodiment shown in FIG. 1, the first sensor 5 and the second sensor 7 are distinct and spaced from each other. This type of positioning may arise from the practical impossibility to position the two sensors in the same position or with the aim of obtaining two distinct views of the scene S. Thus, the representation of the scene S provided by the first sensor 5 (see FIG. 2) and by the second sensor 7 (see FIG. 3) is different. In order to be able to compare the two representations of the scene S, the control unit 4 is configured to receive—in input—a calibration parameter relative to the relative position between the sensor 5 and the sensor 7.

Knowing the relative position between the first sensor 5 and the second sensor 7, the control unit 4 is configured to re-phase the views obtained by the first sensor 5 and by the second sensor 7 and thus enable superimposition thereof as if the scene S were shot from a common position, at a virtual sensor 8 arranged on a predetermined virtual reference plane R. The re-phasing of the views coming from the first sensor 5 and from the second sensor 7 occurs by means of a trigonometric analysis of the scene S and the relative processing of the images. The re-phased scene, with respect to a view corresponding to the position of the virtual sensor 8 along the virtual reference plane R, is shown in FIG. 5. FIG. 5 however shows a configuration of the detection device 1 wherein the position of the virtual sensor 8 is distinct from the first and from the second sensor 5, 7; however, the possibility of defining the virtual sensor at the first sensor 5 or the second sensor 7 cannot be ruled out. This enables superimposing the two-dimensional representation and the three-dimensional representation according to an observation point shared with the first and second sensor.

Besides enabling the superimposition of the scenes shot by the sensors arranged in different positions, this technique can also provide an alternative view depending on the monitoring needs, in particular in cases where the installation position of the first sensor 5 and the second sensor 7 is limited due to practical reasons. For example, should the detection device 1 have two or more of said first sensors 5, the latter can be arranged in different positions so as to guarantee the proper shooting of the scene; the control unit 4 can be configured to receive the respective monitoring signals from said first sensors 5 to define a single three-dimensional representation of the scene S; as a matter fact, the control unit 4 constructs the three-dimensional representation of the scene S by means of the monitoring signals of the plurality of sensors 5. Then, one or more two-dimensional representations that can be obtained by means of one or more monitoring signals that can be generated by one or more second sensors 7 can be superimposed on said three-dimensional representation.

The attached figures illustrate a configuration of the detection device 1 comprising two sensors (a first sensor 5 and a second sensor 7); the possibility of using—for the first embodiment of the device 1—only one sensor (for example the first sensor 5) or a plurality of three-dimensional or two-dimensional sensors cannot be ruled out.

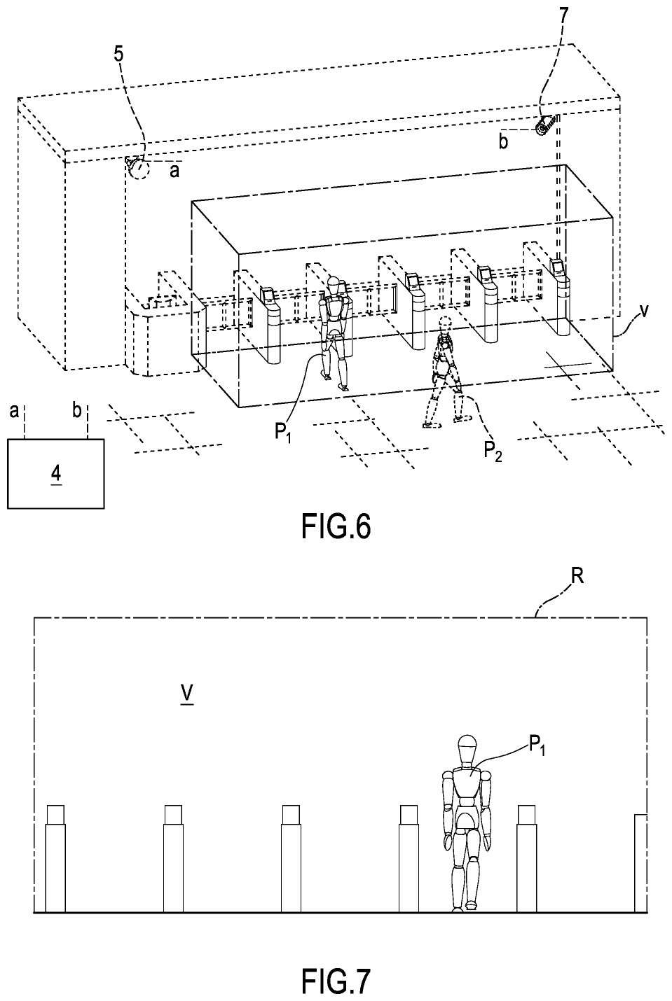

The control unit 4 is also configured to define, from the three-dimensional representation of the scene S, an inspection region V, representing a portion of the three-dimensional representation of the scene S (FIGS. 6 and 7). The inspection region V represents a three-dimensional portion of actual interest to the monitoring of the scene S, thus enabling to purify the signal coming from the first sensor 5 (purifying the representation of the entire scene S) and subsequently thinning the subsequent processing steps. As a matter of fact, the step of defining the inspection region V essentially consists in an extraction of a portion (inspection region) from the three-dimensional representation of the entire scene, i.e. a segmentation of the scene so as to eliminate the representation portions of no interest.

In detail, the control unit 4 is configured to:
compare a value of the identification parameter of a pixel—or at least one part of said pre-set number of pixels—with at least one reference parameter value,
following said comparison step, define the inspection region V as a function of a pre-set relationship between at least one reference parameter value and the identification parameter value of the pixels, optionally the pre-set relationship is defined by a difference between at least one reference parameter value and the identification parameter value of the pixels of at least part of said pre-set number. The step for defining the inspection region V defines the extraction (segmentation) of the representation of the scene S.

The reference parameter comprises a plurality of reference values relative to spatial coordinates of a virtual region representing the inspection region V. The reference parameter alternatively comprises a mathematical function defining a plurality of reference values relative to the spatial coordinates of a virtual region representing the inspection region V.

In other words, the steps carried out by the control unit 4 with the aim of defining the extraction of the inspection region V from the representation of the scene S, enables distinguishing the pixels arranged inside and outside the inspection region V. This extraction of the inspection region V from the scene is also referred to as segmentation of the scene S. FIG. 6 shows a three-dimensional inspection region, optionally rectangle parallelepiped-shaped. In this figure, it can be seen that the inspection region V represents a portion of the overall scene S, including the regions of interest to the monitoring only and wherein the person P2 is excluded from it. However, the inspection region V can be of the two-dimensional type as shown in FIG. 7; in particular, FIG. 7 shows an inspection region V, defined by the 2D front projection of the three-dimensional representation of the scene of FIG. 6. Thus, FIG. 7 shows the presence of the person P1 only and thus excluding the person P2.

Alternatively, or combined with the technique described above, the segmentation of the scene S may be carried out using parametric algorithms capable of recognising predetermined objects and/or people present in the scene S. In particular, the segmentation of the scene S may occur as a function of a relative position between two or more bodies, for example people and/or objects, defined by the cloud of points. Alternatively, or combined with the segmentation techniques described above, the segmentation of the scene S may occur as a function of the shape of one or more bodies, for example people and/or objects, defined by the cloud of points, for example based on recognition, for example carried out by means of parametric algorithms or classifiers, of geometric features such as the planarity, the sphericity, the cylindricity of one or more bodies defined by the cloud of points. Furthermore, the segmentation of the scene S can be carried out by estimating a dimension of one or more bodies, for example people and/or objects or as a function of the chromatic values of the cloud of points or parts thereof. However, techniques for the segmentation of the scene S described above can be executed both on two-dimensional and three-dimensional images. The segmentation techniques described above can be used singularly or in any combination. Due to the extraction of the inspection region V from the scene S, the elements not required for a subsequent analysis can thus be excluded therefrom. This enables reducing the complexity of the scene S, advantageously providing the control unit 4 with a “light” two-dimensional image and thus quicker to analyse. It should also be observed that, should the device be used for determining a situation of alarm or danger, this enables reducing the number of false positives and false negatives that can for example be generated by analysing a complete non-segmented scene S.

The control unit 4 is also configured to perform the projection of at least one among the three-dimensional representation of the scene S and the inspection region V with the two-dimensional representation of the scene S as a function of the calibration parameter. As a matter of fact, a sort of superimposition of the three-dimensional representation (the three-dimensional representation of the scene S or the inspection region V shown in FIG. 6) is carried out on the two-dimensional representation generated by the second sensor 7. The projection is carried out by superimposing each pixel of at least one among the three-dimensional representation of the scene S and the inspection region V with a corresponding pixel of said two-dimensional representation of the same scene. In the case where the first sensor 5 and the second sensor 7 are located in different positions, the use of the calibration parameter enables the correct superimposition of the three-dimensional representation with the two-dimensional representation. The superimposition between the three-dimensional and two-dimensional image enables associating to the cloud of points N of the first three-dimensional sensor 5 the chromatic information provided by the second two-dimensional sensor 7, so as to combine the additional map depth 3D information with the chromatic information of the two-dimensional sensor. In the case where the second two-dimensional sensor 7 does not provide chromatic information (monochromatic sensor), the superimposition between the 2D and 3D image is always advantageous in that it enables combining the better clarity due to the superior spatial resolution offered by the 2D sensor with the depth information provided by the 3D sensor.

In other words, the control unit 4—as a function of the calibration parameter—is configured to associate to at least one pixel of the three-dimensional image at least one pixel of the colour two-dimensional image to determine an estimate of the colour inspection region V. In other words, the control unit 4 is configured to receive—in input—the signal from the second sensor 7 representing the scene S, translating this signal into a colour two-dimensional representation of the scene S (shown only schematically in FIG. 3), and superimpose the colour two-dimensional representation to the three-dimensional representation of the scene S (FIG. 2) or of the inspection region V (FIG. 6). By applying this strategy, the control unit 4 associates the two-dimensional chromatic information provided by the sensor 7 to the inspection region V extracted from the representation of the scene S captured by the first sensor 5. The two-dimensional colour projection of the three-dimensional inspection region V is schematically shown in FIG. 7.

As previously described, the second sensor 7 (for example comprising the RGB or RGB-D camera) is capable of providing a signal representing an image having a superior resolution (quality) with respect to the resolution of the sensor 5: the two-dimensional image that can be obtained by the second sensor 7 has a higher resolution with respect to the three-dimensional image (cloud of points) that can be obtained by the sensor 5 and the detail level of the colour is also higher than that of the three-dimensional representation. As described above, in order to segment the scene S, it is useful to perform the superimposition of the three-dimensional representation of the scene—in particular of the inspection region V—with the two-dimensional representation of the scene S, obviously the calibration parameters being known. Due to this resolution difference by the first and second sensor 5 and 7, the two-dimensional image obtained following said projection (superimposition of 3D and 2D images) could be “perforated”. The control unit 4 can be configured to receive—in input—a perforated region of the image obtained by said projection and fill the blank spaces without causing the modification of the external contours. The algorithm carried out by the control unit 4 is based on a known closing morphological operation.

Besides performing the segmentation step and possibly the step of processing the projected 2D image, the control unit can be configured to modify the image (three-dimensional and/or two-dimensional) to be provided to the classifier by applying a background around the inspection region. In detail, the control unit, following the segmentation step, is configured to apply around the inspection region V a background suitable to define, alongside said region V, the representation of the inspection region V (2D or 3D image) to be provided to the classifier; the background can comprise an image consisting of pixels of the same colour, for example a white image, or an image, optionally filtered, representing the scene S shot during a reference condition different from the condition during which the control unit determines an inspection region V.

In the first described condition, the background consists of an image of a pre-set colour arranged around the segmented image; the control unit is configured to generate the representation of the inspection region V combining the segmented image with the background image: such combination enables creating an image (2D or 3D) wherein the segmented image can be highlighted with respect to the background.

In the second described condition, the background consists of an image representing the scene S shot at a different time instant with respect to the time instant when the representation of the inspection region was sent to the classifier. For example, such background image may comprise an image of the scene S in a reference condition wherein there are no people and/or specific objects searched; the control unit is configured to generate the representation of the inspection region V by combining the segmented image with said image representing the scene shot during the reference condition: such combination enables defining an image (2D or 3D) wherein the segmented image is inserted in the scene S shot during the reference condition. Thus, the segmented image can be positioned in a specific context (for example an ‘airport control area, a check-in area, etcetera). Thus, the classifier, suitably trained, may provide a better identification of the people and/or specific objects also due to the context (background) in which they are inserted.

The control unit is configured to apply the background on images of the two-dimensional or three-dimensional type so as to define said representation of the inspection region, consisting of the segmented representation (image) of the scene and the background. Such representation of the inspection region (two-dimensional or three-dimensional image) is sent to the controller for the step of identifying people and/or objects therein. Such procedure for applying the background following the segmentation step can also be carried out for the for the subsequently described embodiments of the detection device 1.

The control unit 4 is further configured to provide a classifier (for example a neural network) with the representation of the colour or monochromatic inspection region V, so that it can identify and/or locate—based on the representation of the inspection region V—the presence of people P and/or specific objects in the representation of the inspection region V. The control unit can directly provide the classifier with a colour three-dimensional image of the inspection region V (coloured cloud of points) or in scale of greys or the two-dimensional image—colour or in scale of greys —obtained by projecting the inspection region V on a reference plane, for example a virtual reference plane R, by projecting the inspection region V on the colour two-dimensional image that can be obtained by means of the second sensor 7. In detail, the classifier is configured to:
receive a signal representing the inspection region V from the control unit 4,
identify (determine the presence of) people and/or specific objects in said inspection region V,
optionally emit a control signal representing the presence of people P and/or specific objects in said inspection region.

The classifier adopts an approach based on the use of neural networks, or other classification algorithms. Various classifiers based on the use of genetic algorithms, gradient methods, ordinary least squares method, Lagrange multipliers method, or stochastic optimisation methods, can be adopted. In case of use of a neural network, this provides for an alignment session configured to emit a control signal actually corresponding to the presence or absence of people P and/or specific objects in said inspection region V. The neural network alignment session has the purpose of setting the coefficient of the mathematical functions part of the neural network so as to obtain the correct recognition of people P and/or specific objects in the inspection region V.

Upon receiving—in input—the signal representation of the inspection region V, the classifier can process the signal with the aim of determining the presence of people P and/or objects in the inspection region V and provide—in output—a corresponding control signal to the control unit 4. In any case, the control unit can receive—in input—said control signal emitted by the classifier, to perform the verification process concerning the presence of people and/or specific objects in the inspection region. As a matter of fact, the classifier carries out the first determination of the presence of people and objects in the inspection region; the control unit can optionally carry out a subsequent verification on what was actually detected by the classifier.

The control unit 4, as a function of the control signal from the classifier, determines a parameter for detecting the presence of people P and/or specific objects in the inspection region V. The control unit is configured to determine a pre-set situation as a function of a relationship between a detection parameter value and a reference threshold value. The detection parameter comprises at least one of the following elements: the number of people detected in the inspection region, one or more specific people detected in the inspection region, the relative position between two or more people in the inspection region, the number of specific objects in the inspection region, one or more specific objects detected in the inspection region, the type of object detected in the inspection region, the relative position between two or more objects in the inspection region, the relative position between one or more people and one or more objects in the inspection region.

Should the control unit provide the classifier with a colour inspection region, the additional contribution of the chromatic information enables the classifier to process an additional parameter useful for recognising people P and/or objects of the inspection region V, and thus improving the performance thereof. For example, the recognition (identification) of a person in the inspection region can be carried out considering the average intensity of the colours, brightness or colour intensity gradient, etc.

The control unit 4 further comprises at least one memory configured for memorising the classifier. In particular, the memory is configured to memorise the neural network and parameters aggregated thereto.

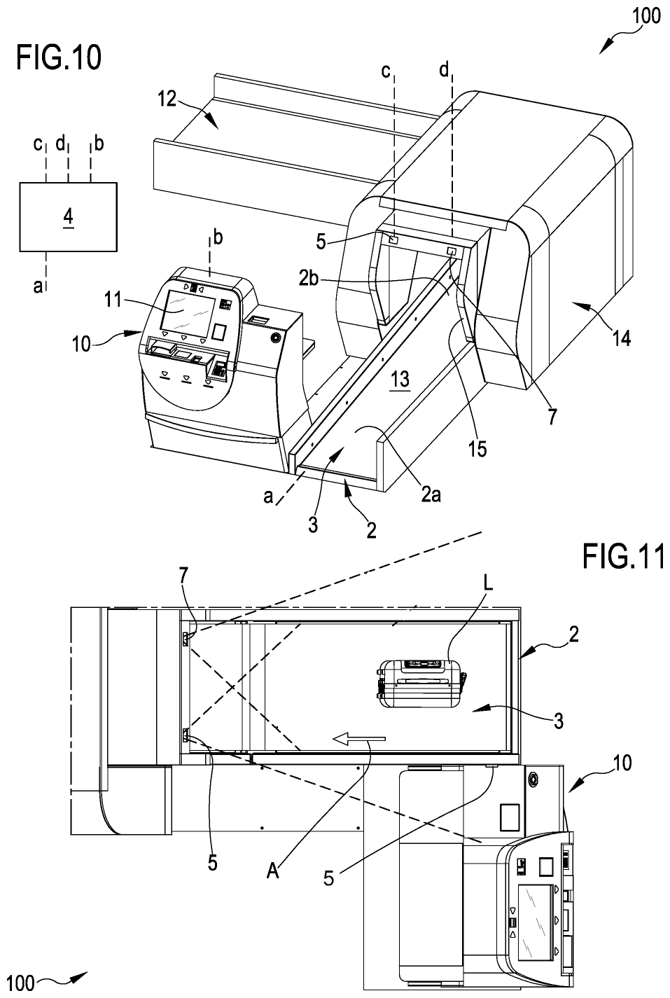

FIGS. 10-16 show—by way of example—a check-in station 100 using the previously described detection device 1. The check-in station 100 can be used in the field of systems for the automatic transfer of articles L of various types, delivery and/or collection and/or loading baggage and packages in ports, airports and similar facilities, in airport check-in areas for moving baggage to be loaded into aircraft.

FIGS. 10 and 11 illustrate a check-in station 100 used for loading baggage, weighing, checking and transferring the same on one or more sorting lines 12 and on a support member. In any case, the check-in station 100 can also be used at industrial level for transferring and/or sorting products of any nature, or even in any field requiring specific conditions for collecting the article (for example for postal shipping).

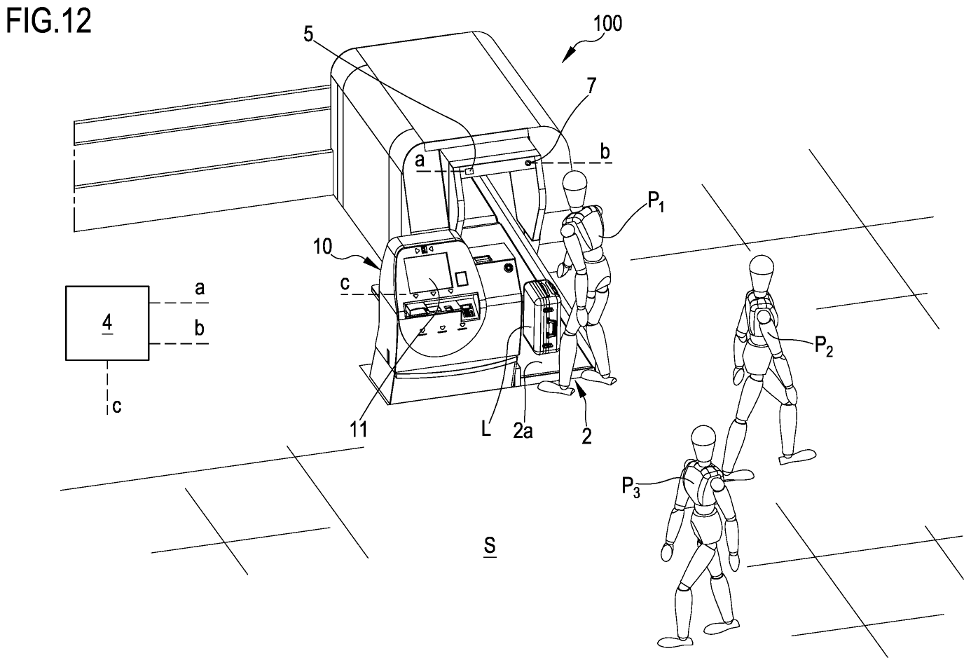

The check-in station 100 (see FIG. 10) comprises a support member configured to receive at least one article L at a loading area 2a. The support member 2 comprises a conveyor 2 extending longitudinally between a loading area 2a and an unloading area 2b; the conveyor 2 is configured to receive at least one article L at the loading area 2a and transfer it up to the unloading area 2b along an advancement direction A. Generally, the conveyor 2 is a system for the automatic removal of the article L from an area for detecting the weight of the article. The conveyor 2 has an exposed surface 13 (FIG. 10) configured for defining an operative section representing the portion of the conveyor 2 designated to receive the article L directly resting thereon and transfer it along the advancement direction A. The conveyor 2 may comprise: at least one conveyor belt, a mat carrying a plurality of free rollers moving rotating around an axis thereof which are suitably positioned in respective cavities of the belt, a transversal rollers system. The attached figures illustrate a conveyor 2 comprising an endless belt wound around one or more terminal rollers, at least one of which is driven. The belt is driven by means of an activation device, for example a motor, which can be directly connected to the belt and drive the same, for example thanks to one or more friction wheels. Alternatively, the activation device can be associated to one or more rollers (the return rollers or the tensioning roller) so as to drive the latter. The friction between the rollers and belt enables driving the latter and transferring the article L. As concerns the materials, the conveyor belt is at least partly made of rubber so as to guarantee an optimal friction between the article, for example a baggage, and the exposed surface 13 of the belt. The control unit 4 is connected to the conveyor 2 (see the “a” dashed connection line for sending/receiving data/controls shown in FIGS. 10 and 12) and configured to control the driving thereof. The control unit 4 is connected to the activation device (for example the electric motor) and it is configured to control the latter so as to manage the driving of the conveyor 2.

The check-in station 100 may comprise a tunnel 14 arranged at the conveyor 2 and configured to cover the latter for at least part of the longitudinal extension thereof (FIG. 10). The tunnel 14 is configured to cover the unloading area 2b: the tunnel does not cover the loading area 2a which must be accessible for positioning the article L on the conveyor 2. The tunnel 14 has a door 15 for the entry of articles L arranged above and around the conveyor 2, and facing towards the loading area 2a of the conveyor 2. The tunnel 14 extends—starting from a first conveyor belt up to the end of a second conveyor belt and thus up to the sorting line 12: the tunnel 14 is configured to define a cover (barrier) of the conveyor 2 suitable to prevent access to the sorting areas and to the passing articles L, if any.

The check-in station 100 may further comprise a weight detector 3 associated to the conveyor 2 and configured to emit a signal relative to the weight of the article L resting on the conveyor 2 (for example see FIGS. 10 and 11). The detector 3 is associated to the operative section of the conveyor 2 at the loading area 2a. From a structural point of view, the weight detector 3 may comprise a weighing scale, such as for example a torsion, hydraulic or pneumatic weighing scale. The control unit 4 is connected to the weight detector 3 and configured to estimate (in particular determine), as a function of the signal received from the weight detector 3, the weight of the article L resting on the conveyor 2. The control unit 4, in a pre-set control condition, may verify whether the weight of the article L (weight estimate) resting on the conveyor 2 meets given limit requirements. For example, during the control condition, the control unit 4 can be configured to:
receive a signal from the weight detector 3,
determine a stability of the weight signal received from the detector,
determine (estimate) the weight of the article L resting on the loading area 2a of the conveyor 2 as a function of said stable signal,
compare the value of the weight detected with the value of a pre-set limit threshold.

Should the control unit 4 determine that the weight of the article P is below the pre-set limit threshold, the same unit 4 is configured to define an article P approval condition: in such condition, the control unit 4 establishes that the article P resting on the conveyor 2 has a weight that falls within the required parameters. In the article L approval condition, the control unit can control the conveyor 2 to transfer the article L, along the advancement direction A, weighed for sending it to the unloading area 2b. On the contrary, should the control unit 4 determine that the weight of the article L is higher than the pre-set weight limit threshold, the unit 4 itself is configured to define a stop condition during which it prevents the driving of the conveyor 2; in the latter condition, the unit 4 prevents articles L exceeding the allowed weight from being sent. Generally, it will be established whether the baggage weight exceeds the allowed maximum limits and thus cannot be loaded, or if, vice versa, the weight—despite exceeding the allowed limit and after following the procedures laid down regarding bulky baggage—can still be loaded (for example upon paying an extra shipping fee).

The check-in station 100 may comprise a check-in desk or station 10 arranged next to the conveyor 2 at the area 2a for loading the article L. The check-in desk 10 is configured to define a sort of control panel for a user suitable to perform pre-set operations for checking the article L to enable the recording thereof and thus sending to the sorting line 12. More in detail, the check-in station 1 comprises a desk 10 for each conveyor; as a matter of fact, a check-in desk 10 is associated to each conveyor belt. The check-in desk 10 comprises a selection device configured to enable a user to select at least one or more of the activities/operations required for check-in comprising recording the article L. The selection device may comprise a display 11, optionally a touch screen display 11 (condition illustrated in the attached figures), or it may alternatively comprise a display with a keyboard and/or mouse associated thereto for entering data and/or selecting the information indicated on the display. The desk 10 may include systems for recognising documents, such as identification documents or travel documents by means of, for example, scanning, optical, magnetic systems etcetera. Furthermore, the check-in desk 10 is provided with a system for dispensing the baggage/s tag and also for dispensing travel documents if needed. Furthermore, the desk may be provided with suitable payment systems, such as credit or debit card readers or the like. The check-in desk 10 is advantageously connected to the control 4 which is configured to receive suitable data from the check-in desk 10. The control unit 4 could be integrated in the desk and thus receive/send data to the user and control the various operations of the station. Alternatively, there could be present several CPUs placed in communication with respect to each other, each dedicated to specific tasks. More in detail, the user is recognised and starts the baggage check-in procedure by means of the check-in desk 10. Upon performing the passenger identification procedure steps, the control unit 10 can activate a procedure, by means of the control unit 4, wherein the activities related to requesting the positioning of the article on the conveyor in view of the subsequent sending to the sorting line 12 by driving the conveyor 2, and request to weighing the article L placed in the loading area 2a, start.

As specified above, the check-in station 100 comprises the device 1 which comprises at least one sensor (optionally at least one sensor 5 and optionally one sensor 7) arranged at the support member 2, and configured to be operatively active with respect to a scene S comprising at least one loading area 2a of the support member (see for example FIGS. 11 and 12 wherein the scene S is schematised). The scene S as described above essentially coincides with a maximum volume given by the union of all field views of all sensors.

The check-in station 100 comprises the first sensor 5, which can be associated to a support member at the loading area 2a or which can be positioned spaced from the loading area 2a, for example at the access door 15 of the tunnel 14 as for example illustrated in FIGS. 10 and 11. Furthermore, the check-in station 100 can comprise the second sensor 7 distinct and spaced from the first sensor 5 and which can also be associated to the support member, in particular to the conveyor 2, at the loading area 2a or which can be positioned spaced from the loading area 2a, for example at the access door 15 of the tunnel 14. Obviously, any number and/or arrangement of sensors may equally be adopted as long as it enables monitoring the desired scene S. During a pre-set monitoring condition, the sensors 5 and 7 are configured to process, for example instant by instant (i.e. in a substantially continuous fashion over time), a signal representing the scene S comprising the loading area 2a. The signal emitted by the sensor represents the environment which comprises the loading area 2a and thus anything that is arranged and being transferred or stationary in said environment.

More in detail, the first sensor 5 is configured to emit a monitoring signal representing a scanning of the pre-set scene S comprising a loading area 2a designated to receive the article L; the sensor 5 is configured to transmit said monitoring signal to the control unit 4. The monitoring signal generated by the first sensor 5 represents the three-dimensional image of the scene S (FIG. 14), thus the article L too as well as the further bodies contained therein. The control unit 4, at least during the control condition, is suitable to reconstruct—in a three-dimensional fashion (with the resolution allowed/set for the sensor/s)—the scene S and in particular it reconstructs the article L and any other further element contained inside the scene S. This 3D reconstruction occurs substantially continuously over time so that, time instant by time instant, the control unit 4 has the three-dimensional data of the scene S which varies upon the variation of the scene, i.e. upon variation of the position of the bodies therein. the sensor 5 is also configured to emit a monitoring signal representing at least one among,
a shape of the article L arranged in the pre-set inspection region,
a dimension of the article L arranged in the pre-set inspection region,
a position of the article L arranged in the pre-set inspection region.

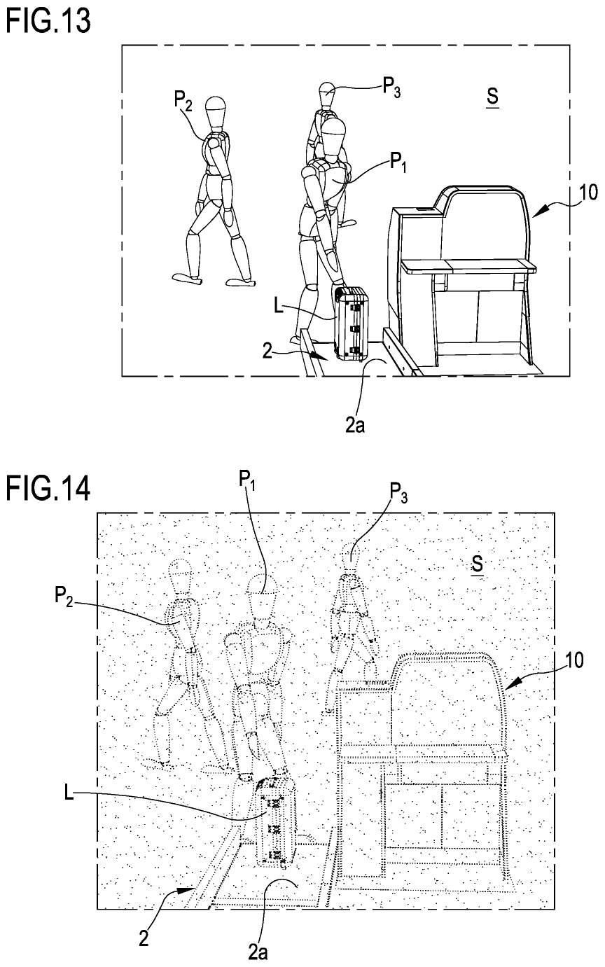

FIGS. 13 and 14 show the representation of the scene S obtained respectively by the first sensor 5 and by the second sensor 7: given that the latter are spaced from each other, the scene S differs in terms of perspective. As previously described, in order to compare the two representations of the scene S, the control unit 4 is configured to receive—in input—the calibration parameter regarding the relative position between the first sensor 5 and the second sensor 7 and carry out the projection (superimposition) of at least one among the three-dimensional representation of the scene S and the inspection region V with the colour two-dimensional representation of the scene S as a function of the calibration parameter. In other words, knowing the relative position between the first sensor 5 and the second sensor 7, the control unit is configured to re-phase the views coming from the first sensor 5 and from the second sensor 7 and thus enables the superimposition thereof.

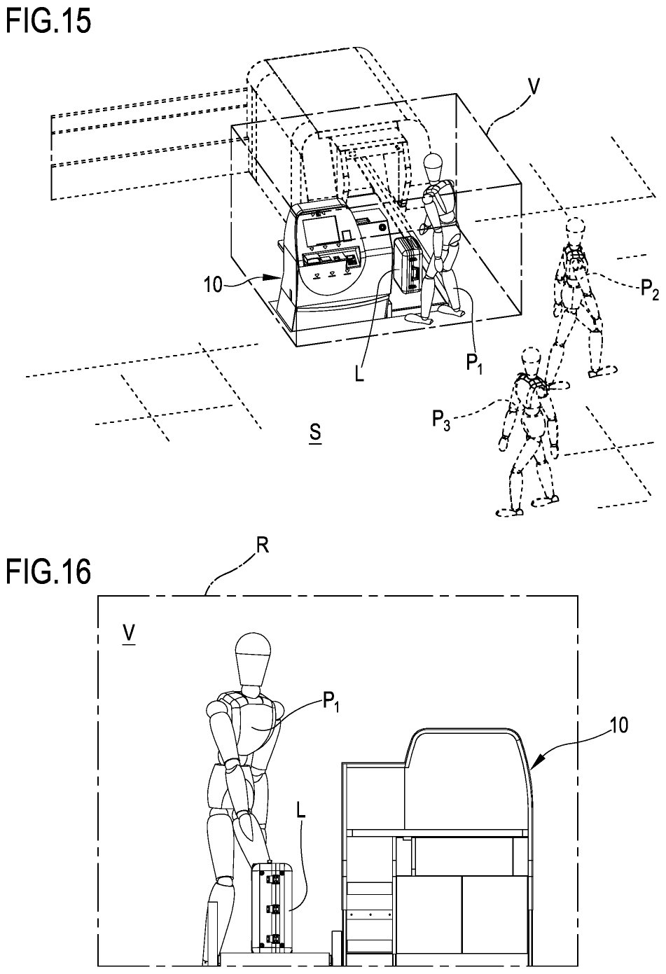

Using the same operative steps described in the case of the inspection device 1, the control unit 4 is configured to extract, from the three-dimensional representation of the scene S of the check-in station, an inspection region V, having a smaller extension with respect to the overall extension of the three-dimensional surface representing the entire scene (see FIG. 15). Thus, the inspection region V represents the three-dimensional portion of the scene S of actual interest to the monitoring, in the particular case including the person P1, the baggage L, the check-in desk 10 and the conveyor 2. The inspection region V, represented in FIG. 15—solely by way of example—by a rectangle parallelepiped-shaped, can take various shapes defined a priori, as previously described in detail. The section of the inspection region V can be square, rectangular, elliptical, circular, trapezoidal shaped or a combination thereof. The inspection region can be represented both by a three-dimensional volume and by a two-dimensional surface. It should be observed that the people P2 and P3 shown in FIG. 15 are outside the inspection region V and thus not taken into account for monitoring purposes.

Should the check-in station 100 comprise the second sensor 7, the control unit 4 is connected to the latter and configured to receive the respective monitoring signal representing the scene S. As a function of said respective monitoring signal, the control unit is configured to estimate a two-dimensional representation, advantageously a colour two-dimensional representation, of the scene S, and to project the three-dimensional representation of the scene S or the inspection region V on the colour two-dimensional representation of the same scene S so as to obtain at least one colour representation, in particular two-dimensional, of the inspection region V, as shown in FIG. 16. By applying this strategy, the control unit 4 associates the two-dimensional chromatic information provided by the second sensor 7 to the inspection region V. FIG. 16 schematically shows a monochromatic representation of a 2D projection of the three-dimensional inspection region V.

The control unit 4 is configured to provide the classifier with the representation of the inspection region V thus obtained, so that the latter can identify (optionally locate)—based on the representation of the inspection region V—people P and/or specific objects in the representation of the inspection region V. The classifier receives the signal representing the inspection region V from the control unit 4 and emits a control signal representing the presence of people P and/or specific objects in the inspection region V. The control unit 4, as a function of the control signal from the classifier, determines a parameter for detecting the presence of people P and/or baggage L in the inspection region V; the control unit is configured to determine an intrusion situation as a function of a pre-set relationship between a pre-set detection parameter value and the reference threshold value.

Based on the aforementioned parameters, the control unit is configured to detect at least one among: the number of people detected in the inspection region, one or more specific people detected in the inspection region, the relative position between two or more people in the inspection region, the number of specific objects in the inspection region, one or more specific objects detected in the inspection region, the type of object detected in the inspection region, the relative position between one or more people and one or more objects in the inspection region, the number of articles detected in the inspection region, the relative position between an article and a person whose presence has been detected in the inspection region.

Thus, the control unit 4 can carry out the dimensional control on the baggage L to verify whether it falls within the maximum dimensions required by the transportation company. Should the article have exceeded the allowed dimensions, the control unit 4 can command the stopping of the article L recording procedure and notify the user about this stop by means of the check-in desk 10.

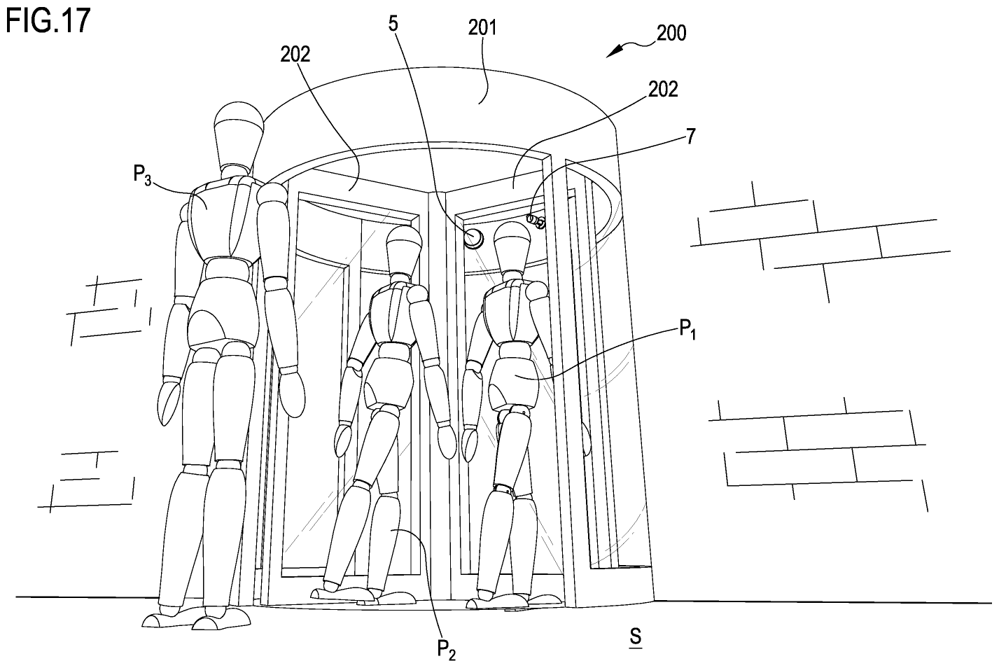

On the other hand, FIGS. 17-19 show a station 200 for access to the rotating automatic doors using the previously described detection device 1. For example, the access station 200 can be used for regulating access to a specific area by one or more people P; in particular, the detection device 1 associated to the present application enables acting on the driving of one or more rotating doors based on a predetermined access parameter, for example as a function of the number of people present adjacent to the rotating doors.

The station 200 for access to the rotating automatic doors comprises a structure 201 (see FIGS. 17 and 22), advantageously a cylindrical-shaped structure having an access area and an exit area configured to enable one or more people P and/or animals and/or objects respective access and exit from the structure 201. The structure 201 comprises—therein—one or more mobile rotating doors 202 (see FIGS. 17 and 22) for rotation with respect to a vertical axis advantageously arranged centrally with respect to the structure 201. The structure 201 may comprise 3 rotating doors 202 arranged at 120° from each other with respect to the same vertical axis. The space portion comprised between two adjacent rotating doors and the structure 201 defines a volume configured to house at least one person P and/or animal and/or object when they are passing from the access area to the exit area of the structure 201. The access and exit from inside the structure 201 compulsorily depends on the relative position between the rotating doors 202 and the access and exit areas of the structure 201. The rotating doors 202 and the access and exit areas are configured so that, with the rotating doors blocked, it is forbidden to pass from the access area to the exit area and vice versa. The rotating doors 202 can be driven by means of an electric motor configured to drive the rotating doors 202 with respect to a predefined direction so as to allow the entry of one or more people P through the access area and the ensuing exit from the exit area. The electric motor is also configured to define the blocking of the rotating doors 202 so that the driving by rotation is constrained.

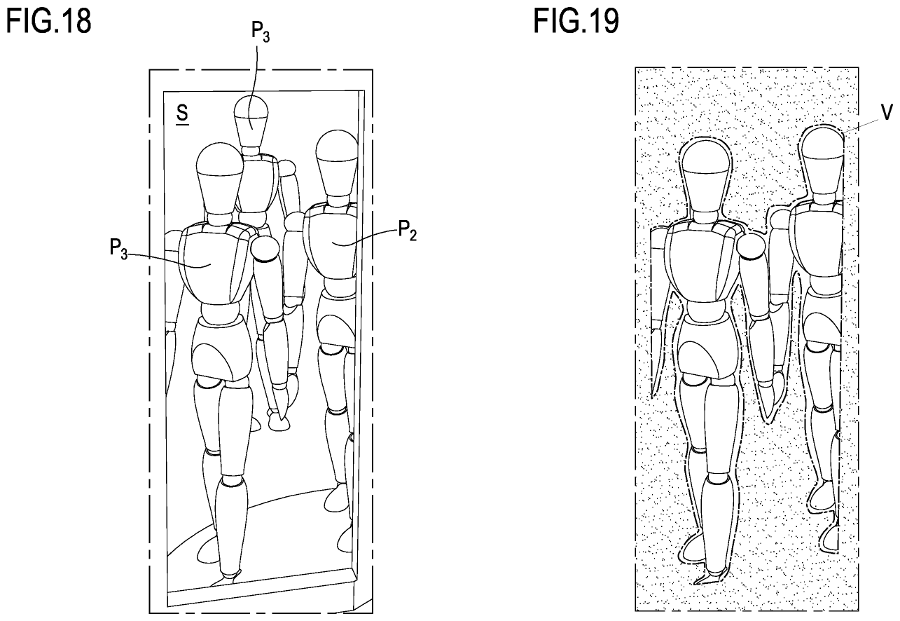

Just like for the previously described applications, the area for access to the rotating automatic doors 200 comprises a sensor configured to provide a colour or monochromatic three-dimensional representation of the scene S. In an embodiment, the area for access to rotating automatic doors 200 comprises the first sensor 5 and the second sensor 7 shown in FIGS. 17 and 22. The first and the second sensor 5 and 7 are mounted on the structure 201, in particular inside, so as to obtain a view comprising the access area and/or the exit area of the same structure 201. FIG. 18 schematically shows—by way of example—a view of the second sensor 7, showing the people P1 and P2 in the access area and the person P3 positioned outside the structure 201.

The detection device 1 combined with the access station 200 further comprises, as previously described, a control unit 4 configured to receive the monitoring signal from the sensors 5 and 7, as a function of the monitoring signal, estimate a three-dimensional representation of the scene S, extract the inspection region V from the three-dimensional representation of the scene S and provide the classifier with a representation of the inspection region V. Based on the representation of the inspection region V, the control unit determines—by means of the classifier—the presence of people P and/or specific objects in the representation of said inspection region V, as shown in FIG. 19. It is observable that the inspection region V shown in FIG. 19 reproduces the person P1 and P2 while the person P3, outside the structure 201, is not included, in that external to the inspection region V based on the information of the depth map provided by the first sensor 5. The extraction process of the inspection region is identical to the one described previously in detail regarding the check-in station and the narrow access area.

The control unit 4 is also connected to the electric motor driving the rotating doors 202, in a manner such to control the activation or blocking. In particular, the activation and blocking of the doors occurs as a function of the control signal provided by the classifier to the control unit and representing the presence of people and/or specific objects in the colour two-dimensional inspection region V. As a matter of fact, the control unit 4 is configured to receive the control signal from the classifier and determine, as a function of said control signal, the presence of people and/or specific objects in the colour two-dimensional image. For example, should the classifier identify the presence of more than one person and the control unit determine that one or more said people are at the access area or in the volume defined between the two adjacent rotating doors in any case, the same control unit is configured to emit an alarm signal and/or block the driving of the rotating doors 202 by controlling the electric motor connected thereto.

The control unit 4 is configured to perform the functions described above essentially in real time; more in detail, the control unit is configured to receive at least one monitoring signal from the at least one sensor (in particular from all sensors of the device 1) with a frequency variable between 0.1 and 200 Hz, in particular between 1 Hz and 120 Hz. More in detail, the control unit 4 is configured to generate the inspection region V and to determine any alarm situation with a frequency variable between 0.1 and 200 Hz, in particular between 1 Hz and 120 Hz, so as to perform an analysis of the scene in real time. As a matter of fact, the number of representations (three-dimensional and/or two-dimensional of the scene or portions thereof) per second that can be generated by the control unit 4 vary as a function of the technology applied (type of sensors, control unit and classifier) and the needs of the specific application.

In some applications, especially industrial applications, the analysis time and hardware costs, which determine the calculation power, are restrictions of fundamental importance. The classifiers can be configured to reduce the image (two-dimensional or three-dimensional) to be analysed to a suitable fixed dimension and irrespective of its initial dimensions. Should the classifier provide an estimate of the positions of the detected objects and/or objects, several images coming from one or more sensors acquired in the same instant or different instants can be combined in a single image (two-dimensional or three-dimensional): this image (combination of the two-dimensional or three-dimensional type) is transferred to the classifier. The estimated positions being known, the results can be attributed to the relative initial image.

### 1.2 Second Embodiment of the Detection Device 1

The detection device 1 according to a second embodiment is configured to be used for detecting people and/or specific objects and/or animals in a scene. For example, the detection device 1 can be used for:
recognising people and/or animals and/or specific objects on conveyor belts in airports,
recognising people in critical areas due to safety reasons,
recognising the type of baggage in an automatic check-in system,
recognising the passing through of more than one person in double doors, revolving doors, entrances,
recognising dangerous objects in double doors, revolving doors, entrances,
recognising the type of packages on conveyor belts and/or roller units, for example separators and sorters, in the logistics/postal industries,
morphological analysis of pallets in the logistics industry,
recognition of people in airport waiting areas, for example baggage collection carousels, so as to customise advertising messages,
postural analysis in human/machine interaction to identify dangerous conditions for human beings and/or prevention of injuries,
dimensional and/or colorimetric evaluation in the live and/or slaughtered animals food industry,
dimensional e/o colorimetric evaluation in the fruits and vegetables food industry,

It should be observed that the fields of application indicated above shall be deemed solely for exemplifying purposes and thus non-limiting with respect to the possible use of the detection device 1.

The detection device 1 according to the present second embodiment comprises a sensor configured to emit a monitoring signal representing a scene S and a control unit 4 connected to the sensor. In detail, the device 1 comprises the first sensor 5 and the second sensor 7 distinct from each other, having the same type and principle of operation described previously with respect to the first embodiment (see FIGS. 1, 10, 17).

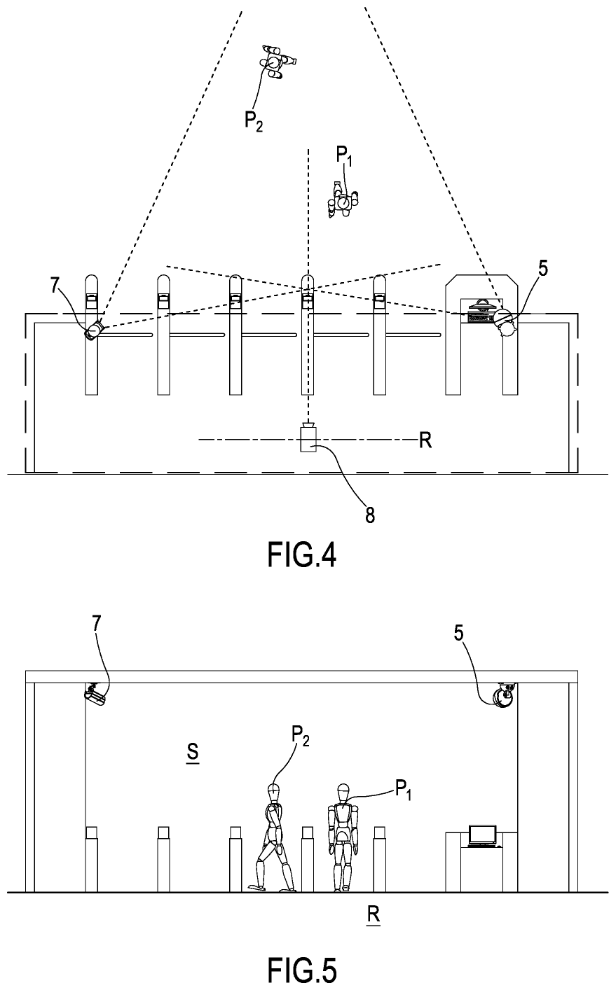

Should the first and second sensor be installed in different positions, the representation of the scene S provided by the first sensor 5 (see FIG. 2) and by the second sensor 7 (see FIGS. 3, 13, 18) is different. In order to be able to compare the two representations of the scene S, the control unit 4 is configured to receive—in input—a calibration parameter corresponding to the relative position between the first sensor 5 and the second sensor 7. In other words, as previously described regarding the first embodiment and as shown in FIG. 4, knowing the relative position between the first sensor 5 and the second sensor 7, the control unit 4 is configured to re-phase the views obtained by the first sensor 5 and the second sensor 7 and thus enable superimposition thereof as if the scene S were shot from a common position, at a virtual sensor 8 arranged on a predetermined virtual reference plane R.

The detection device 1 further comprises a control unit 4 configured to receive the sensor, in particular from the first sensor 5 and from the second sensor 7, the monitoring signal, as a function of which a two-dimensional representation of the scene S and at least one three-dimensional representation of the scene S are estimated. The control unit 4 is configured to estimate a three-dimensional representation of the scene S from which the three-dimensional information of the scene S is extracted (see FIGS. 2 and 14). In other words, the three-dimensional representation of the scene S comprises the three-dimensional information of the scene S itself. The control unit 4 is also configured to generate a cloud of points N defining the estimate of the three-dimensional representation of the scene S, in particular the cloud of points N defines a depth map of the three-dimensional representation of the scene S hence to each pixel there corresponds a two-dimensional information and a further depth information. Alternatively, the control unit 4 can obtain the cloud of points by associating the depth map to the camera calibration parameters.

The three-dimensional information associated to the representation of the scene S may comprise a relative position of each pixel with respect to a pre-set reference system, alternatively represent a relative position of a first pixel representing a first body, for example a person and/or an object, with respect to a second pixel representing a second body, for example a person and/or an object. Furthermore, the three-dimensional information may comprise a shape of at least one body, for example a person and/or an object, defined by one or more pixels of the three-dimensional image, or a dimension of at least one body, for example a person and/or an object, defined by one or more pixels of the three-dimensional image. Optionally, the three-dimensional information comprises chromatic values associated to each pixel.

As previously described regarding the first embodiment, the relative position of the three-dimensional information of each pixel comprises at least one minimum distance of said pixel from an origin defined by means of spatial coordinates of a three-dimensional Cartesian reference system, a minimum distance of said pixel from an origin defined by means of polar coordinates of a cylindrical coordinates reference system or a minimum distance of said pixel from an origin defined by means of polar coordinates of a spherical coordinates reference system.

Thus, the control unit 4 is configured to provide the classifier with the two-dimensional representation of the scene S or projection on the reference plane, for example a virtual reference plane R, of the two-dimensional representation of the scene S, shown in FIGS. 5 and 18. The two-dimensional representation of the scene S that the classifier is provided with is obtained by means of a second sensor 7.

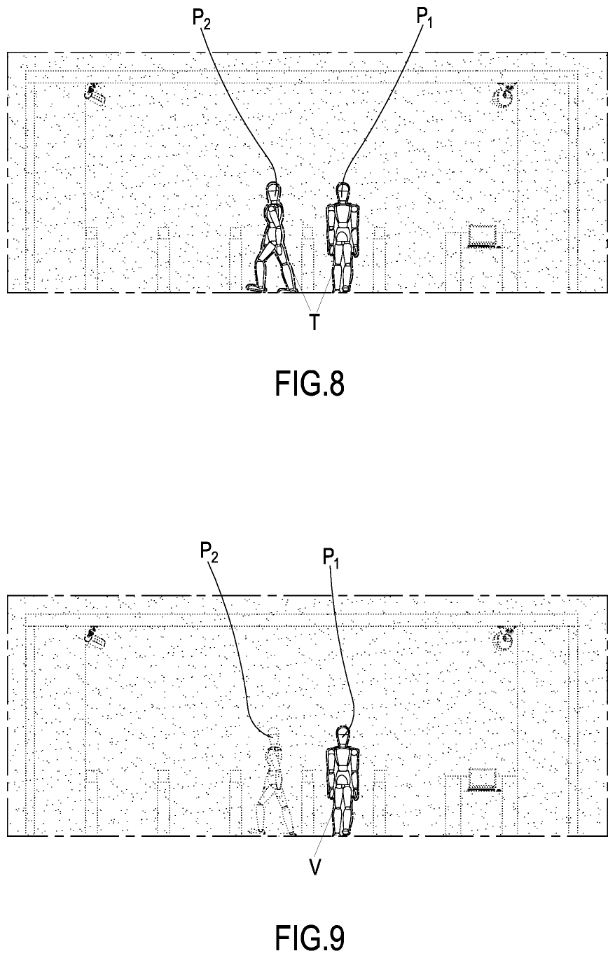

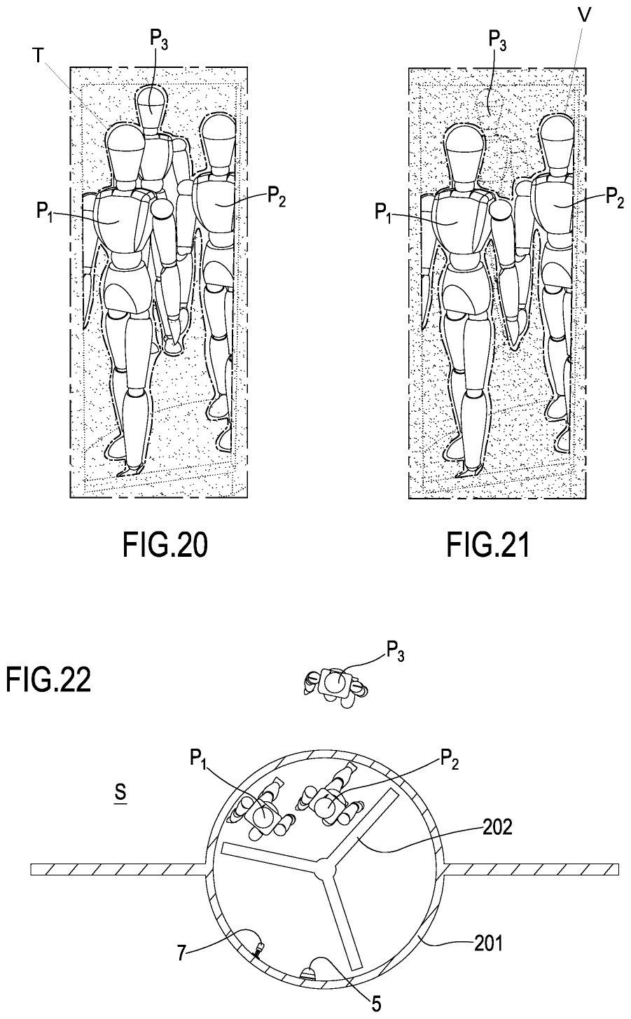

The control unit 4 is configured to determine, by means of the classifier, the presence of people P and/or specific objects in the two-dimensional representation of the scene S, as shown in FIGS. 8 and 20. In particular, the classifier is configured to locate people P and/or objects and/or animals in the two-dimensional representation of the image representing the scene S, as well as identifying the position thereof in the two-dimensional image. The control unit 4 is optionally configured to process the two-dimensional representation of the scene S as a function of at least one filtering parameter to define at least one filtered two-dimensional representation of the scene S to be sent to the classifier. The filtering parameter comprises at least one among:
the position of a person identified in the two-dimensional representation of the scene S,
the relative position of a person identified in the two-dimensional representation of the scene S with respect to another person and/or specific object,
the shape of a body identified in the two-dimensional representation of the scene S,
the dimension of a body identified in the two-dimensional representation of the scene S,
the chromatic values of a body identified in the two-dimensional representation of the scene S,
the position of an object identified in the two-dimensional representation of the scene S,
the relative position of a specific object identified in the two-dimensional representation of the scene S with respect to a person and/or another specific object,
a pre-set region of interest in the two-dimensional representation of the scene S, optionally defined by means of image coordinates (values in pixels). In detail, such filter provides for cutting out a pre-set region of the two-dimensional representation of the scene S so as to exclude regions of no interest for the classifier a priori.

In other words, the two-dimensional representation of the scene S can be previously filtered prior to being sent to the classifier, so as to filter or eliminate predefined portions of the two-dimensional representation of the scene S, thus lightening the computational load carried out by the classifier for the subsequent analysis.

Thus, the control unit defines—as a function of the two-dimensional representation (filtered or non-filtered)—at least one control region T at least partly containing at least one person and/or specific object whose presence was predetermined, in the two-dimensional representation of the scene S (or in the filtered two-dimensional representation), by means of the classifier (see FIGS. 8 and 20). The control region T is defined by a portion of the two-dimensional representation of the scene S, it has a smaller surface extension with respect to the overall surface extension of the two-dimensional representation of the scene S. Given that the two-dimensional image consists of a plurality of pixels each having a chromatic information, the control region T is defined by a pre-set number of these pixels, hence the number of pixels of the control region is smaller than the overall number of pixels of the two-dimensional image.

The control unit 4, subsequently to the step of defining the control region T, is configured to allocate the three-dimensional information of at least one pixel of the three-dimensional representation of the scene S provided by the first sensor 5, to the control region T. The control unit 4 is configured to allocate the three-dimensional information of a respective pixel of the three-dimensional information to each pixel of the control region T. Should a pixel of the three-dimensional image fail to find a corresponding pixel of the two-dimensional image in the same position of representation of the scene S, the local information can be recreated using the closing morphological operation described in detail in the first embodiment.

As a function of a pre-set relationship between the three-dimensional information allocated to said control region T and a three-dimensional reference parameter, the control unit 4 is configured to extract at least one inspection region V from said control region T shown in FIGS. 9 and 21. With the aim of defining the inspection region V, the control unit 4 is configured to compare a three-dimensional information value of at least one pixel of the control region T with a three-dimensional reference parameter value, and subsequently define the inspection region V as a function of a pre-set relationship between the three-dimensional information value and the three-dimensional reference parameter value. Based on this comparison, and in particular should the three-dimensional information value differ from the three-dimensional reference parameter value exceeding a given threshold, the control unit extracts the inspection region V from the control region T. In other words, the control unit excludes at least part of the control region T from the inspection region V. Based on the same comparison, and in particular should the three-dimensional information value differ from the reference parameter value within the limits of the pre-set threshold, the control unit 4 associates the control unit T to the inspection region V. Thus, the inspection region V comprises a portion of the three-dimensional surface having a smaller extension with respect to the overall extension of the three-dimensional surface representing the entire scene S. In other words, the inspection region V represents a portion of the representation of the scene S solely containing the information filtered by the control unit, for example portions of an image showing people and/or animals and/or objects, and simultaneously meeting the requirements defined by the three-dimensional reference parameter.

FIGS. 8 and 20 schematically show the control region T obtained by processing the two-dimensional representation of the scene S by means of the recognition information obtained by the classifier. It should be observed that by processing the two-dimensional image, the classifier contributes towards defining a control region T showing, in FIG. 8, both the people P1 and P2, while FIG. 20 shows the people P1, P2, P3, present in the scene S.

FIGS. 9 and 21 show the inspection region V as a portion of the control region T, wherein the person P2 of FIG. 8 and the person P3 of FIG. 20 are outside the inspection region V based on the comparison carried out between the three-dimensional information value of at least one pixel of the control region T and the three-dimensional reference parameter value.

Upon defining the inspection region V, the control unit 4 is configured to determine a detection parameter regarding the presence of people P and/or specific objects and/or animals in the inspection region V. Based on the detection parameter, more in particular based on a pre-set relationship between a detection parameter value and a reference threshold value, the control unit 4 is configured to determine an alarm situation.

The detection parameter comprises at least one among: the number of people detected in the inspection region, one or more specific people detected in the inspection region, the relative position between two or more people in the inspection region, one or more specific objects detected in the inspection region, the number of specific objects in the inspection region, the type of object detected in the inspection region, the relative position between two or more objects in the inspection region, the relative position between one or more people and one or more objects in the inspection region.

The alarm situation defined by the control unit can be defined as a function of the field of application. For example, the alarm situation can be the sound signal in the case of the check-in station 100 or blocking the rotating doors 202 in the case of the access station 200.

In a variant of the second embodiment of the device 1, the control unit 4 is configured to segment the three-dimensional representation of the scene S generated as a function of the of the monitoring signal of the at least one sensor. In this case, the control unit 4 is configured to estimate at least one three-dimensional information of the segmented three-dimensional representation of the scene S; thus, only the information of the segmented three-dimensional representation of the scene will be associated to the control region T so as to define the inspection region V. Actually, in the second embodiment of the device 1, the control unit 4 is configured to implement the segmentation of the three-dimensional representation of the scene as described regarding the first embodiment of the device 1. The segmented three-dimensional representation is then used for extracting the three-dimensional information of the scene to be associated to the two-dimensional representation (filtered or non-filtered). In other words, in the second embodiment the segmentation of the three-dimensional representation can be interpreted as a sort of filter applied to the three-dimensional representation so as to reduce the number of three-dimensional information to be superimposed (associated) to the two-dimensional representation which can also be subjected or not subjected to filtering at the two-dimensional level irrespective of the segmentation of the three-dimensional representation: this enables performing an efficient definition of the inspection region V.

The control unit 4 is configured to perform the tasks described above essentially in real time; in particular, the control unit 4 is configured to generate the control regions T, the inspection regions V and for determining any alarm situations with a frequency variable between 0.1 and 200 Hz, in particular between 1 Hz and 120 Hz, so as to obtain an analysis of the scene essentially in real time. As specified above, the number of representations (three-dimensional and/or two-dimensional of the scene or portions thereof) per second that can be generated by the control unit 4 vary as a function of the technology applied (type of sensors, control unit and classifier) and the needs of the specific application.

Just like in the first embodiment, the control unit can be configured to reduce the image (two-dimensional or three-dimensional) to be sent to the classifier for identifying people and/or objects to a suitable fixed dimension and irrespective of the initial dimensions. Should the classifier provide an estimate of the positions of the detected objects and/or objects, several images coming from one or more sensors acquired in the same instant or different instants can be combined in a single image (two-dimensional or three-dimensional): this image (combination of the two-dimensional or three-dimensional type) is transferred to the classifier. The estimated positions being known, the results can be attributed to the relative initial image.

### 1.3 Third Embodiment of the Detection Device 1

Described below is a detection device 1 according to a third embodiment. The possible fields of application of the detection device 1 according to the present third embodiment are the same as the ones mentioned above, for example the detection device 1 can be used in a narrow access area (see FIG. 1), in a baggage check-in station 100 (see FIG. 12) in airports and in an access station 200 (see FIG. 17) with rotating automatic doors. The third embodiment provides for the possibility of comparing different representations of a scene S shot from two or more sensors arranged in different positions, providing an alternative view at a virtual sensor 8 (described previously regarding the first embodiment) as a function of the monitoring needs, in particular should the installation position of the sensors be limited for practical reasons.

The detection device 1 comprises at least two sensors distinct from each other and arranged at a different position. In particular, the detection device 1 comprises at least one first sensor 5 (see FIGS. 1, 10 and 17) configured to emit a three-dimensional monitoring signal representing a scene S seen from a first observation point (FIGS. 2 and 14) and a second sensor 7 (FIGS. 1, 10, 17) distinct and spaced from the first sensor 5: the second sensor is configured to emit a respective two-dimensional monitoring signal representing the same scene S seen from a second observation point different from the first observation point.

Furthermore, the detection device 1 comprises a control unit 4 (see FIGS. 1, 12) connected to the first and second sensor, and configured to receive from the first and from the second sensor 5 and 7 the respective monitoring signals, as a function of at least one of which the three-dimensional representation of the scene S is estimated. Thus, the control unit 4 is configured to project the three-dimensional representation of the scene S at least on a reference plane R, for example a virtual reference plane R, with the aim of estimating a three-dimensional representation of the scene S seen from a third observation point of the scene, in particular seen by the virtual sensor 8.

It should be observed that the third observation point of the scene S, for example corresponding to the position of the virtual sensor 8, is different from the first and/or from the second observation point of the scene S (see FIG. 5).

In the third embodiment, the first and the second sensor are configured to generate respective monitoring signals of the scene representing the three-dimensional scene seen from different observation points. Thus, the sensors 5 and 7 can be positioned (option not shown in the attached figures) distinct from each other and installed in different positions so as to obtain the monitoring signals defining the three-dimensional representations of the scene S seen from a first and a second observation point. The control unit 4 is thus configured to estimate the three-dimensional representation of the scene S seen from a first observation point, estimate a three-dimensional representation of the scene S seen from a second observation point, and superimpose the three-dimensional representations of the scene estimated respectively as a function of the monitoring signal of the first and second sensor to form a single three-dimensional representation of the scene S. The control unit 4 is then configured to project the single three-dimensional representation of the scene S on the reference plane R, for example the virtual reference R, so as to estimate a two-dimensional or three-dimensional representation of the scene S seen from a third observation point of the scene S, optionally seen by the virtual sensor 8. The single three-dimensional representation of the scene S comprises a depth map, consisting of a pre-set number of pixels, each pixel comprises the identification parameter representing the position of the pixel in the space with respect to a pre-set reference system. Should the detection device 1 comprise two colour three-dimensional sensors, the colour three-dimensional representations of the scene S can be projected on the reference plane R, for example the virtual reference plane R, so as to obtain a single colour three-dimensional representation and thus the possibility of extracting a colour two-dimensional representation of the scene S optionally seen by the virtual sensor 8.

To summarise, should the two sensors be installed in different positions, the representations of the scene S provided by the first sensor 5 (see FIG. 2) and by the second sensor 7 (see FIGS. 3, 13, 18) are different. In order to be able to compare the two representations of the scene S, and project them on the reference plane R, for example the virtual reference plane, the control unit 4 is configured to receive—in input—a calibration parameter corresponding to the relative position between the first sensor 5 and the second sensor 7. A description of the calibration parameter was previously introduced regarding the first embodiment. In other words, as previously described according to the first embodiment of the device 1 and as shown in FIG. 4, knowing the relative position between the first sensor 5 and the second sensor 7, the control unit 4 is configured to re-phase the views obtained by the first sensor 5 and by the second sensor 7 and thus enables superimposition thereof as if the scene S were shot from a common position, optionally at a virtual sensor 8 arranged on a predetermined reference plane R. In the third embodiment of the detection device 1, the first sensor 5 may comprise at least one selected among: an RGB-D camera, an RGB camera, a 3D light field camera, an infrared camera, (in particular an infrared-ray depth dual sensor consisting of an infrared projector and a camera sensitive to the same band), an IR camera, a UV camera, a laser camera (in particular a 3D laser scanner), a time-of-flight camera, a structured light optical measuring system, a stereoscopic system, a single-pixel camera, a thermal camera.

Still in the third embodiment of the detection device 1, the second sensor 7 may comprise at least one selected among: an RGB-D camera, an RGB camera, a 3D light field camera, an infrared camera, (in particular an infrared-ray depth dual sensor consisting of an infrared projector and a camera sensitive to the same band), an IR camera, a UV camera, a laser camera (in particular a 3D laser scanner), a time-of-flight camera, a structured light optical measuring system, a stereoscopic system, a single-pixel camera, a thermal camera.

For example, each sensor 5, 7 is configured to provide a colour or monochromatic three-dimensional representation of the scene S defining a cloud of points N, optionally a depth map consisting of a pre-set number of pixels, wherein the control unit 4 is configured to allocate to each pixel of the three-dimensional image an identification parameter representing the position of the pixel in the space with respect to a pre-set reference system. The identification parameter of each pixel comprises a minimum distance of the pixel from an origin defined by means of spatial coordinates and/or polar coordinates of a three-dimensional Cartesian reference system and/or cylindrical or spherical coordinates.

According to the first embodiment of the device 1, the control unit 4 is also configured to determine, in particular to extract the inspection region V from the three-dimensional representation of the scene S and project a representation of the former on the reference plane, for example on the virtual reference plane R, to obtain the two-dimensional representation of the scene S. In the specific case, the inspection region V is extracted from the three-dimensional representation of the scene S. The inspection region V is extracted from the projection of the three-dimensional or two-dimensional representation of the scene S on the reference plane R, seen by the virtual sensor 8. The extraction of the inspection region V has already been described in-depth above regarding the first embodiment, to which reference shall be made for further details. It should be observed that the inspection region V comprises both two-dimensional and three-dimensional information.

As a matter of fact, the control unit—as a function of the monitoring signal respectively of the first sensor and of the second sensor—is configured for estimating at least the three-dimensional representation of the scene defined by the composition of the three-dimensional representations of the scene that can be generated by means of the monitoring signal of the first and second sensor 5, 7. The control unit 4 is then configured to provide a classifier, designated to identify people and/or specific objects, with at least one image, representing the three-dimensional representation of the scene. The image may comprise a three-dimensional image of the scene seen from a third observation point distinct from the first and second observation point of the sensors 5 and 7 or it may comprise a two-dimensional image. More in detail, the control unit is configured to project the three-dimensional representation of the scene S at least on a first reference plane (for example a virtual reference plane) to define said image: the image being a two-dimensional representation of the scene seen from a third observation point.

Lastly, the control unit 4 is configured to determine—by means of the classifier—the presence of people P and/or specific objects in said image. For a detailed description on the type and principle of operation of the classifier, reference shall be made to the detailed description regarding the first embodiment of the device 1. The control unit 4 is configured to provide the classifier with the two-dimensional representation of the scene S projected on the plane R, by means of which the presence of people P and/or specific objects is determined in the two-dimensional representation of the scene S. The control unit 4 is also optionally configured to process the colour or monochromatic two-dimensional representation of the scene S prior to sending it to the classifier, as a function of at least one filtering parameter to extract at least the region of interest containing at least one person and/or specific object. As previously described regarding the second embodiment, the filtering parameter comprises at least one among: the position of a person identified in the two-dimensional representation of the scene, the relative position of a person identified in the two-dimensional representation of the scene with respect to another person and/or specific object, the shape of a body identified in the two-dimensional representation of the scene, the dimension of a body identified in the two-dimensional representation of the scene, the chromatic values of a body identified in the two-dimensional representation of the scene, the position of an object identified in the two-dimensional representation of the scene, the relative position of a specific object identified in the two-dimensional representation of the scene with respect to a person and/or another specific object, a specific region of interest in the two-dimensional representation of the scene S, optionally defined by means of image coordinates (values in pixels).

The two-dimensional representation of the scene S thus filtered is then sent by the control unit to the classifier for recognising people P and/or objects and the ensuing definition of the control region T. According to the second embodiment and as previously described, the inspection region is extracted from the control region T by associating the information regarding the three-dimensional representation of the scene S projected on the plane R to the control region T as a function of the three-dimensional reference parameter. As previously described in-depth regarding the first and second embodiment of the device 1, the control unit 4 is configured to determine the detection parameter regarding the presence of people P and/or specific objects in the region of interest (inspection region or two-dimensional representation of the scene S), so as to define the alarm situation as a function of a pre-set relationship between a pre-set detection parameter value and a reference threshold value. In particular, the detection parameter comprises at least one selected among: the number of people detected in the inspection region or region of interest, one or more specific people detected in the inspection region or region of interest, the relative position between two or more people in the inspection region or region of interest, one or more specific objects detected in the inspection region or region of interest, the number of specific objects in the inspection region or region of interest, the type of object detected in the inspection region or region of interest, the relative position between two or more objects in the inspection region or region of interest, the relative position between one or more people and one or more objects in the inspection region or region of interest.

As a matter of fact, in the third embodiment of the device 1 the operation of the control unit can be carried out as described for the first embodiment of the device 1 to segment the three-dimensional representation of the scene that can be generated by means of the signals of the sensors 5 and 7; following the segmentation, there can be obtained an inspection region V from which the image to be provided to the classifier to determine the presence of people and/or specific objects in the image can be obtained; alternatively, the inspection region (three-dimensional representation of the segmented scene) may thus be projected on the plane R so as to obtain a two-dimensional image representing the inspection region seen from the third observation point distinct from the first and second observation point respectively of the first and second sensor.

Still in the embodiment of the device 1 the operation of the control unit can be carried out as described for the second embodiment of the device 1 to obtain a control region T, and subsequently an inspection region, from a two-dimensional representation of the scene S.

As concerns the described embodiment of the detection device 1 too, the control unit 4 is configured to perform the functions described above essentially in real time; in particular, the control unit is configured to receive at least one monitoring signal from the sensors (in particular from all sensors of the device 1) with a frequency variable between 0.1 and 200 Hz, in particular between 1 Hz and 120 Hz. More in detail, the control unit 4 is configured to provide a classifier with at least one image representing the three-dimensional representation of the scene and possibly determine any alarm situations with a frequency variable between 0.1 and 200 Hz, in particular between 1 Hz and 120 Hz, so as to perform an analysis of the scene in real time. As a matter of fact, the number of images per second that can be generated by the control unit 4 (images sent and analysed by the classifier) vary as a function of the technology applied (types of sensors, control unit and classifier) and the needs of the specific application.

Just like in the first and second embodiment, the control unit can be configured to reduce the image (two-dimensional or three-dimensional) to be sent to the classifier for analysing at a suitable fixed dimension and irrespective of the initial dimensions. Should the classifier provide an estimate of the positions of the detected objects and/or objects, several images coming from one or more sensors acquired in the same instant or different instants can be combined in a single image (two-dimensional or three-dimensional): this image (combination of the two-dimensional or three-dimensional type) is transferred to the classifier. The estimated positions being known, the results can be attributed to the relative initial image.

1.-13. (canceled)

14. A detection device comprising:
a sensor configured to emit a monitoring signal representing a scene,
a control unit connected to the sensor and configured to:
receive the monitoring signal from the sensor,
estimate a three-dimensional representation of the scene as a function of said monitoring signal,
determine an inspection region from the three-dimensional representation of the scene,
provide a classifier with a representation of the inspection region,
determine a presence of people and/or specific objects in the representation of said inspection region based on the representation of the inspection region and using the classifier.

15. The detection device according to claim 14, wherein the control unit, as a function of the monitoring signal, is configured to estimate the three-dimensional representation of the as being scene defined by a cloud of points,
wherein the three-dimensional representation of the scene comprises a three-dimensional image representing the scene consists of a pre-set number of pixels, and
wherein the control unit is further configured to allocate to each pixel of the three-dimensional image, for at least part of said pre-set number of pixels, an identification parameter representing a position of said pixel in the space with respect to a pre-set reference system.

16. The detection device according to claim 15, wherein the control unit —during the step of determining the inspection region is configured to:
compare a value of the identification parameter of at least one of the pixels of the three-dimensional image, of at least part of said pre-set number of pixels, with at least one reference parameter value, and
following said comparison of a value, define the inspection region as a function of a pre-set relationship between at least one reference parameter value and the identification parameter value of the pixels of the three-dimensional image of at least part of said pre-set number.

17. The detection device according to claim 16, wherein the at least one reference parameter comprises at least one of:
a relative position of each pixel with respect to a pre-set reference system;
a relative position between two or more bodies defined by the cloud of points;
a shape of one or more bodies defined by the cloud of points;
a dimension of one or more bodies defined by the cloud of points;
chromatic values of the cloud of points or parts thereof.

18. The detection device according to of claim 15, wherein said identification parameter of each pixel further comprises at least one of:
a distance of said pixel from an origin defined by means of spatial coordinates of a three-dimensional Cartesian reference system;
a distance of said pixel from an origin defined by means of polar coordinates of a cylindrical coordinate reference system; and
a distance of said pixel from an origin defined by means of polar coordinates of a spherical coordinates reference system.

19. The detection device according to claim 14, further comprising at least one first sensor and at least one second sensor distinct from the at least one first sensor,
wherein the at least one second sensor is configured to emit a respective monitoring signal representing the scene, wherein the control unit is connected to the second sensor and it is configured to:
receive the respective monitoring signal from the second sensor,
estimate a color two-dimensional representation of the scene as a function of said respective monitoring signal,
superimpose at least part of the inspection region on said color two-dimensional representation of the scene to obtain at least one color representation,
wherein the control unit is configured to:
receive at least one calibration parameter regarding a relative position between the first sensor and second sensor, and
superimpose the inspection region and the two-dimensional representation of the scene as a function of said at least one calibration parameter.

20. The detection device according to claim 19, wherein the at least one second sensor is configured to generate a color two-dimensional image representing the scene and formed by a pre-set number of pixels, and
wherein the control unit, as a function of the calibration parameter, is configured to associate to at least one of pixel in the three-dimensional image representing the inspection region, at least one pixel of the color two-dimensional image to obtain an estimate of the color inspection region,
wherein the control unit is configured to:
provide the classifier with a color representation of the inspection region,
identify, by means of the classifier, presence of people and/or specific objects in said inspection region based on the color representation of the inspection region.

21. The detection device according to claim 20, wherein the control unit is configured to:
project the color two-dimensional representation of the scene on a reference plane to obtain a color two-dimensional image of the inspection region,
provide the classifier with said color two-dimensional image of the inspection region,
wherein the classifier is configured to:
receive a signal representing said color two-dimensional image from the control unit,
determine the presence of people and/or specific objects in said two-dimensional and color image.

22. The detection device according to claim 20, wherein the control unit is configured to process the color two-dimensional representation of the scene as a function of at least one filtering parameter to extract at least one region of interest containing at least one person and/or one specific object from the color two-dimensional representation of the scene,
wherein said filtering parameter comprises at least one of:
a position of a person identified in the two-dimensional representation of the scene;
a relative position of a person identified in the two-dimensional representation of the scene with respect to another person and/or specific object;
a shape of a body identified in the two-dimensional representation of the scene;
a dimension of a body identified in the two-dimensional representation of the scene;
a chromatic values of a body identified in the two-dimensional representation of the scene;
a position of an object identified in the two-dimensional representation of the scene;
a relative position of a specific object identified in the two-dimensional representation of the scene with respect to a person and/or another specific object; and
a pre-set region of interest in the two-dimensional representation of the scene defined by means of image coordinates.

23. The detection device according to claim 22, wherein the control unit is configured to generate, as a function of said filtering parameter, a segmented color two-dimensional image defined by a plurality of pixels of the pre-set region of interest only,
wherein the control unit is configured to associate to at least one pixel of the three-dimensional image representing the inspection region, at least one pixel of the segmented color two-dimensional image to obtain a color estimate of the inspection region,
wherein the control unit is configured to:
provide a classifier with a color representation of the inspection region,
identify, using the classifier, the presence of people and/or specific objects in said inspection region based on the color representation of the inspection region.

24. The detection device according to claim 14, wherein the control unit, upon determining the inspection region, is configured to apply a background around the inspection region to define said representation of the inspection region,
wherein the background comprises:
an image consisting of pixels of a same color,
an image representing the scene shot during a reference condition different from the condition during which the control unit determines said inspection region.

25. The detection device according to claim 14, wherein the control unit is configured to identify an alarm situation as a function of a pre-set relationship between a pre-set detection parameter value and a reference threshold value,
wherein the detection parameter comprises at least one of:
a number of people detected in the inspection region;
one or more specific people detected in the inspection region;
a relative position between two or more people in the inspection region;
a number of specific objects in the inspection region;
one or more specific objects in the inspection region;
a type of object detected in the inspection region;
a relative position between two or more objects in the inspection region;
a relative position between one or more people and one or more objects in the inspection region.

26. The detection device according to claim 14, wherein the control unit is configured to:
project the representation of the inspection region on a reference plane to obtain a two-dimensional image of the inspection region, and
provide the classifier with said two-dimensional image of the inspection region.

27. A detection device comprising:
at least one sensor configured to emit a first monitoring signal representing a scene seen from a first observation point,
at least one second sensor distinct and spaced from the first sensor, said second sensor configured to emit a second monitoring signal representing the scene as seen from a second observation point different from the first observation point,
a control unit in communication with the first and second sensor, said control unit configured to:
receive the first monitoring signal from the first sensor,
receive the second monitoring signal from the second sensor,
generate at least one three-dimensional representation of the scene as a function of the monitoring signal of the first sensor and of the second sensor,
provide a classifier with at least one image of the three-dimensional representation of the scene,
determine, by using the classifier, a presence of people and/or specific objects in said image,
wherein control unit is configured to project the three-dimensional representation of the scene at least on a first reference plane to define said image, wherein said image is a two-dimensional representation of the scene as seen from a third observation point, and
wherein the third observation point is distinct from at least one of the first and the second observation points.

28. The detection device according to claim 27, wherein the control unit is configured to:
determine an inspection region from the three-dimensional representation of the scene, and
project a representation of the inspection region on the at least one reference plane to obtain the two-dimensional representation of the scene.

29. The detection device according to claim 28, wherein the control unit, during the step of determining the inspection region, is configured to:
compare a value of the identification parameter of at least one pixel of the three-dimensional image—of at least one part of said pre-set number of pixels—with at least one reference parameter value,
following said comparison step, define the inspection region as a function of a pre-set relationship between at least one reference parameter value and the identification parameter value of the pixels of the three-dimensional image of at least part of said pre-set number.

30. The detection device according to claim 29, wherein the control unit is configured to determine a detection parameter relative to the presence of people and/or specific objects in the two-dimensional representation in the inspection region.
wherein the control unit is configured to determine an alarm situation as a function of a pre-set relationship between a pre-set detection parameter value and a reference threshold value,
wherein the detection parameter comprises at least one of:
a number of people detected in the inspection region,
one or more specific people detected in the inspection region,
a relative position between two or more people in the inspection region,
a number of specific objects in the inspection region,
a type of object detected in the inspection region,
a relative position between two or more objects in the inspection region,
a relative position between one or more people and one or more objects in the inspection region.

31. The detection device according to claim 27, wherein the control unit is configured to:
estimate at least one three-dimensional representation of the scene seen from a first observation point as a function of the monitoring signal of the first sensor,
estimate at least one three-dimensional representation of the scene seen from a second observation point as a function of the monitoring signal of the first sensor,
superimpose the three-dimensional representations of the scene estimated respectively as a function of the monitoring signal of the first and second sensor to form a single three-dimensional image,
projecting said three-dimensional image at least on a virtual reference plane so as to estimate at least one two-dimensional representation of the scene seen from a third observation point of the scene.

32. The detection device according to claim 27, wherein the first sensor comprises an RGB-D camera and the second sensor comprises a respective RGB-D camera,
the control unit is configured to:
receive the monitoring signal from the first sensor,
generate a color cloud of points defining the color three-dimensional representation of the scene seen from a first observation point,
receive the monitoring signal from the second sensor,
generate a color cloud of points defining the color three-dimensional representation of the scene seen from a second observation point,
superimpose said color three-dimensional representations of the scene estimated respectively as a function of the monitoring signal of the first and second sensor to form a single color three-dimensional image of the scene, and
project said color three-dimensional image of the scene at least on a virtual reference plane so as to estimate at least one color two-dimensional representation of the scene seen from a third observation point of the scene.

33. The detection device according to claim 27, wherein the control unit is configured to process the two-dimensional representation of the scene as a function of at least one filtering parameter for extracting at least one region of interest containing at least one person and/or one specific object,
wherein said filtering parameter comprises at least one of:
a position of a person identified in the two-dimensional representation of the scene,
a relative position of a person identified in the two-dimensional representation of the scene with respect to another person and/or specific object,
a shape of a body identified in the two-dimensional representation of the scene,
a dimension of a body identified in the two-dimensional representation of the scene,
chromatic values of a body identified in the two-dimensional representation of the scene,
a position of an object identified in the two-dimensional representation of the scene,
a relative position of a specific object identified in the two-dimensional representation of the scene with respect to a person and/or another specific object, and
a pre-set region of interest in the two-dimensional representation of the scene.
